(19) United States
(12) Patent Application Publication
(10) Pub. No.: US 2026/0138361 A1
(43) Pub. Date: May 21, 2026

(54) Control Method, Liquid Ejecting Apparatus, And Ink Jet System

(71) Applicant: SEIKO EPSON CORPORATION, Tokyo (JP)

(72) Inventor: Akira MIYAGISHI, Shiojiri (JP)

(21) Appl. No.: 19/389,202

(22) Filed: Nov. 14, 2025

(30) Foreign Application Priority Data
Nov. 15, 2024 (JP) 2024-199517

(51) Int. Cl. B41J 2/045

(52) U.S. Cl. CPC B41J 2/0451; B41J 2/04508; B41J 2/0455; B41J 2/04581; B41J 2/04588

(57) ABSTRACT

A control method of a liquid ejecting apparatus that includes a liquid ejecting head having a plurality of piezoelectric elements, a plurality of pressure chambers which apply pressure to an internal liquid by respectively driving the plurality of piezoelectric elements, and a plurality of nozzles which respectively communicate with the plurality of pressure chambers and from which the liquid is ejected, and that is configured to eject the liquid onto a medium, includes an acquisition step of acquiring residual vibration information on residual vibration in the pressure chambers after applying a voltage to one or more of the plurality of piezoelectric elements, and a determination step of determining whether or not a first abnormality, which is an abnormality in which liquid pool is formed on a nozzle surface on which the plurality of nozzles are provided, is generated based on the residual vibration information.

The present application is based on, and claims priority from JP Application Serial Number 2024-199517, filed Nov. 15, 2024, the disclosure of which is hereby incorporated by reference herein in its entirety.

### BACKGROUND

### 1. Technical Field

The present disclosure relates to a control method, a liquid ejecting apparatus, and an ink jet system.

### 2. Related Art

In the related art, a liquid ejecting apparatus including a liquid ejecting head that ejects a liquid on a medium such as printing paper is provided. In such a liquid ejecting apparatus, an ejection abnormality in which a liquid cannot be normally ejected from a nozzle may be generated due to a liquid ejecting head, such as thickening of a liquid in the liquid ejecting head. For example, JP-A-2004-314459 describes a technique for determining the presence or absence of an ejection abnormality of a liquid ejecting head, such as air bubbles mixed in a liquid in the liquid ejecting head, thickening of the liquid in the liquid ejecting head, and paper dust adhering to a nozzle surface of the liquid ejecting head, based on residual vibration generated after the liquid ejecting head is driven.

In the above-described liquid ejecting head, in addition to the mixing of air bubbles, the thickening of the liquid, and the adhesion of paper dust, the ejection abnormality may be generated due to the generation of liquid pool on the nozzle surface. However, in the related art, it is difficult to determine whether or not the abnormality in which the liquid pool is formed is generated.

### SUMMARY

According to an aspect of the present disclosure, there is provided a control method of a liquid ejecting apparatus that includes a liquid ejecting head having a plurality of piezoelectric elements, a plurality of pressure chambers which apply pressure to an internal liquid by respectively driving the plurality of piezoelectric elements, and a plurality of nozzles which respectively communicate with the plurality of pressure chambers and from which the liquid is ejected, and that is configured to eject the liquid onto a medium, the control method including an acquisition step of acquiring residual vibration information on residual vibration in the pressure chambers after applying a voltage to one or more of the plurality of piezoelectric elements, and a determination step of determining whether or not a first abnormality, which is an abnormality in which liquid pool is formed on a nozzle surface on which the plurality of nozzles are provided, is generated based on the residual vibration information.

According to another aspect of the present disclosure, there is provided a liquid ejecting apparatus that includes a liquid ejecting head having a plurality of piezoelectric elements, a plurality of pressure chambers which apply pressure to an internal liquid by respectively driving the plurality of piezoelectric elements, and a plurality of nozzles which respectively communicate with the plurality of pressure chambers and from which the liquid is ejected, and that is configured to eject the liquid onto a medium, the liquid ejecting apparatus including an acquisition section configured to acquire residual vibration information on residual vibration in the pressure chambers after applying a voltage to one or more of the plurality of piezoelectric elements, and a determination section configured to determine whether or not a first abnormality, which is an abnormality in which liquid pool is formed on a nozzle surface on which the plurality of nozzles are provided, is generated based on the residual vibration information.

According to still another aspect of the present disclosure, there is provided an ink jet system including a liquid ejecting apparatus that includes a liquid ejecting head having a plurality of piezoelectric elements, a plurality of pressure chambers which apply pressure to an internal liquid by respectively driving the plurality of piezoelectric elements, and a plurality of nozzles which respectively communicate with the plurality of pressure chambers and from which the liquid is ejected, and that is configured to eject the liquid onto a medium, and a server provided outside the liquid ejecting apparatus, in which the liquid ejecting apparatus acquires residual vibration information on residual vibration in the pressure chambers after applying a voltage to one or more of the plurality of piezoelectric elements, and transmits the residual vibration information from the liquid ejecting apparatus to the server, and the server determines whether or not a first abnormality, which is an abnormality in which liquid pool is formed on a nozzle surface on which the plurality of nozzles are provided, is generated based on the residual vibration information, and transmits determination information indicating a determination result indicating whether or not the first abnormality is generated to the liquid ejecting apparatus.

### BRIEF DESCRIPTION OF THE DRAWINGS

FIG. 1 is a schematic diagram illustrating a configuration example of an ink jet system according to a first embodiment.

FIG. 2 is a diagram illustrating an example of a configuration of a server.

FIG. 3 is a diagram illustrating a configuration of a processing apparatus.

FIG. 4 is a schematic diagram illustrating an example of a configuration of an ink jet printer.

FIG. 5 is a block diagram illustrating a configuration example of the ink jet printer.

FIG. 6 is a cross-sectional view illustrating a configuration example of a head chip.

FIG. 7 is an enlarged cross-sectional view illustrating a vicinity of a piezoelectric element.

FIG. 8 is a block diagram illustrating an example of a configuration of a liquid ejecting head.

FIG. 9 is a diagram illustrating a timing chart for describing an operation of the ink jet printer in a recording period.

FIG. 10 is a diagram describing residual vibration with respect to a liquid pool generation nozzle.

FIG. 11 is a diagram illustrating functions of the ink jet system.

FIG. 12 is a flowchart illustrating operations of the ink jet system.

FIG. 13 is a flowchart illustrating liquid pool flag setting processing.

FIG. 14 is a diagram for describing a relationship between a threshold value λA and a threshold value λB.

FIG. 15 is a flowchart illustrating liquid pool determination processing.

FIG. 16 is a flowchart illustrating liquid pool flag setting processing according to a second embodiment.

FIG. 17 is a flowchart illustrating liquid pool flag setting processing according to a first modification example.

FIG. 18 is a flowchart illustrating operations of an ink jet system according to a second modification example.

FIG. 19 is a diagram illustrating functions of an ink jet printer according to a third modification example.

FIG. 20 is a schematic diagram illustrating an example of a configuration of an ink jet printer according to an eighth modification example.

### DESCRIPTION OF EMBODIMENTS

Hereinafter, embodiments for carrying out the present disclosure will be described with reference to the drawings. However, in each drawing, the dimensions and scales of each part are appropriately different from the actual ones. In addition, since the embodiment described below is a suitable specific example of the present disclosure, various technically preferable limitations are added, and the scope of the present disclosure is not limited to these embodiments unless otherwise stated in the following description to particularly limit the present disclosure.

### 1. First Embodiment

### 1-1. Overview of Ink Jet System 10

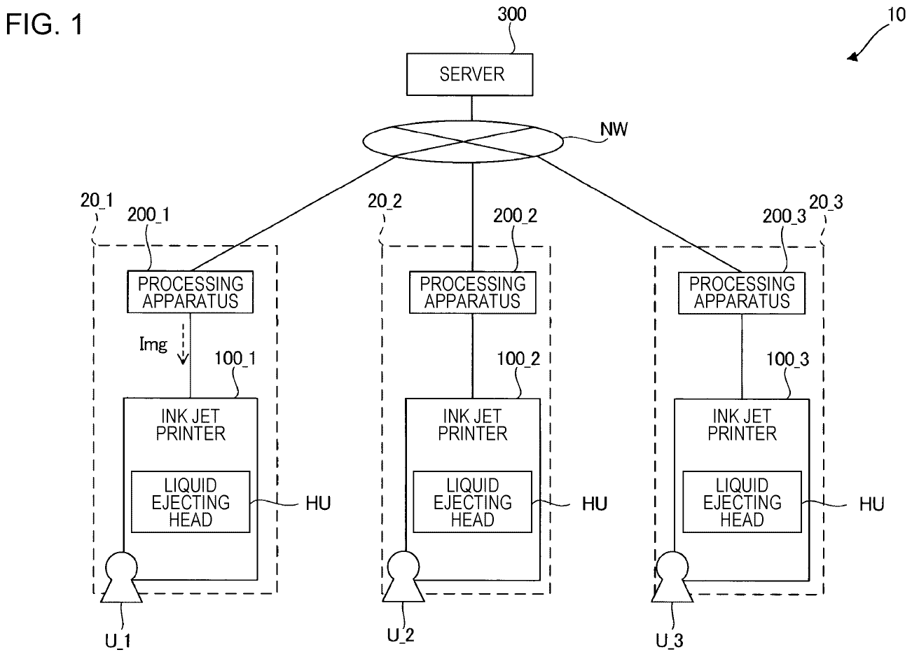

FIG. 1 is a schematic diagram illustrating a configuration example of an ink jet system 10 according to a first embodiment. The ink jet system 10 is a system that performs recording processing on a medium PP, which will be described later, by an ink jet method. In the example illustrated in FIG. 1, the ink jet system 10 includes ink jet printers 100_1 to 100_3, processing apparatuses 200_1 to 200_3, and a server 300.

Here, the ink jet printers 100_1 to 100_3 are apparatuses provided by a manufacturer of the ink jet printers 100_1 to 100_3. In the following description, the ink jet printers 100_1 to 100_3 may be collectively referred to as an ink jet printer 100 without distinguishing among them. The ink jet printer 100 is a liquid ejecting apparatus that ejects ink, which is an example of a liquid. A manufacturer of the ink jet printer 100 is a company that manufactures the ink jet printer 100. The manufacturer of the ink jet printer 100 may be referred to as a “printer manufacturer”. Each of the ink jet printers 100_1 to 100_3 may be provided by the same printer manufacturer or may be provided by different printer manufacturers. However, liquid ejecting heads HU incorporated in the ink jet printers 100_1 to 100_3 are provided by the manufacturer of the liquid ejecting head HU. The manufacturer of the liquid ejecting head HU is a company that manufactures the liquid ejecting head HU. Hereinafter, the manufacturer of the liquid ejecting head HU may be referred to as a “head manufacturer”. The printer manufacturer receives the provision of the liquid ejecting head HU from the head manufacturer, and manufactures the ink jet printer 100 by incorporating the provided liquid ejecting head HU into the ink jet printer 100. The ink jet printer 100 is an example of a “liquid ejecting apparatus”.

FIG. 1 illustrates a user U_1 who uses the ink jet printer 100_1, a user U_2 who uses the ink jet printer 100_2, and a user U_3 who uses the ink jet printer 100_3. In the following description, the users U_1 to U_3 may be collectively referred to as a user U without distinguishing each of the users U_1 to U_3. For the user U, for example, when a worker belonging to a printer manufacturer uses the ink jet printer 100, this worker is the user U. In addition, for example, when a third party who has received the provision of the ink jet printer 100 from the printer manufacturer uses the ink jet printer 100, this third party is the user U. In the following description, the third party who has received the provision of the ink jet printer 100 from the printer manufacturer may be referred to as an “end user”. For each integer i from 1 to 3, a user U_i uses a processing apparatus 200_i in addition to an ink jet printer 100_i.

The ink jet printer 100_1 is communicatively connected to the processing apparatus 200_1. The ink jet printer 100_2 is communicatively connected to the processing apparatus 200_2. The ink jet printer 100_3 is communicatively connected to the processing apparatus 200_3. In this way, the ink jet printers 100_1 to 100_3 correspond to the processing apparatuses 200_1 to 200_3, respectively, and are communicatively connected to the processing apparatuses 200_1 to 200_3. In the following description, the processing apparatuses 200_1 to 200_3 may be collectively referred to as a processing apparatus 200 without distinguishing each of the processing apparatuses 200_1 to 200_3.

In addition, in the following, a recording system 20_i may be described for each integer i from 1 to 3. The recording system 20_i includes the ink jet printer 100_i and the processing apparatus 200_i. In the following description, recording systems 20_1 to 20_3 may be collectively referred to as a recording system 20 without distinguishing each of the recording systems 20_1 to 20_3. It can be said that the ink jet system 10 includes the recording systems 20_1 to 20_3 and the server 300.

In the example illustrated in FIG. 1, the number of each of the ink jet printers 100 and the processing apparatuses 200 included in the ink jet system 10 is three, but the number is not limited thereto, and may be one, two, or four or more. That is, the number of sets of the ink jet printer 100 and the processing apparatus 200 is not limited to three sets, and may be one, two, or four or more sets.

The ink jet printer 100 receives image data Img indicating an image from the processing apparatus 200. The ink jet printer 100 forms an image based on the image data Img on the medium PP. Hereinafter, processing for forming an image on the medium PP by ejecting the ink onto the medium PP may be referred to as “recording processing”.

The medium PP is not particularly limited as long as it is a medium on which the ink jet printer 100 can print, and is, for example, various types of paper, various cloths, various films, or the like.

The ink jet printer 100 has the one liquid ejecting head HU. In the following description, the liquid ejecting head HU ejects ink from a nozzle Nz provided in the liquid ejecting head HU. In the following, among the elements constituting the ink jet printer 100, the elements other than the liquid ejecting head HU may be referred to as a “printer main body”.

In the example illustrated in FIG. 1, the ink jet printer 100 has the one liquid ejecting head HU, but the number of the liquid ejecting heads HU is not limited to one, and may be two or more.

The processing apparatus 200 is a desktop or laptop computer, or the like. The processing apparatus 200 is communicatively connected to the server 300 via a network NW such as a LAN, a WAN, and the Internet. LAN is an abbreviation for Local Area Network. WAN is an abbreviation for wide area network.

The server 300 is a computer that functions as a cloud server CS, which will be described later. The server 300 is managed by, for example, a provider different from a head manufacturer, a printer manufacturer, and an end user. Hereinafter, the provider that manages the server 300 may be referred to as a “server provider”. The head manufacturer uses a part of the server 300.

### 1-2. Configuration of Server 300

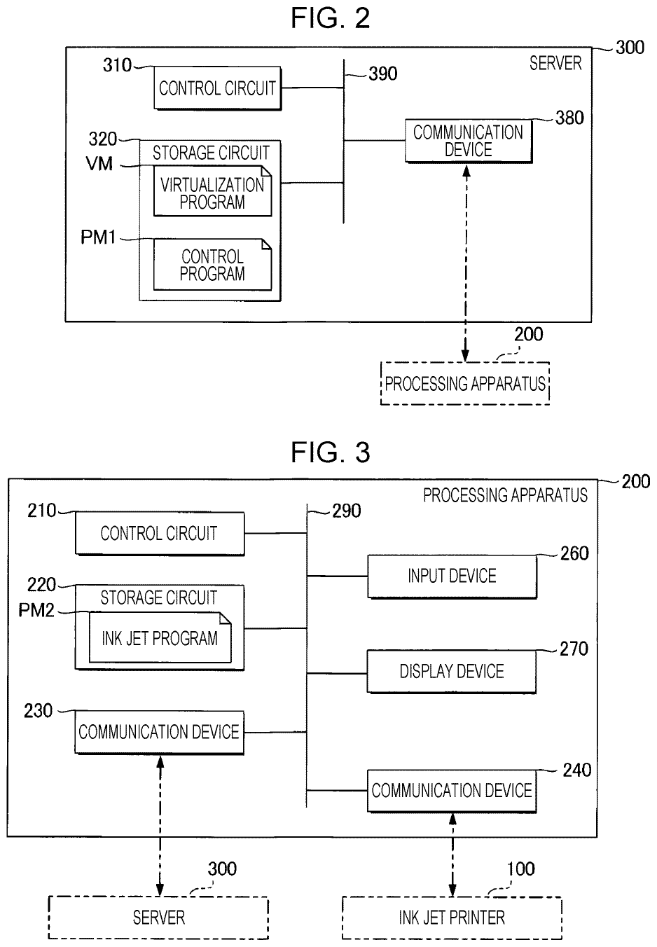

FIG. 2 is a diagram illustrating an example of a configuration of the server 300. The server 300 includes a control circuit 310, a storage circuit 320, and a communication device 380. The control circuit 310, the storage circuit 320, and the communication device 380 are coupled to one another via a bus 390 for communicating information.

The control circuit 310 includes, for example, a processor such as one or more CPUs. CPU is an abbreviation for Central Processing Unit. The control circuit 310 may include a programmable logic device such as an FPGA instead of or in addition to the CPU. FPGA is an abbreviation for Field Programmable Gate Array.

The storage circuit 320 is composed of a magnetic storage device, a flash ROM, or the like. The storage circuit 320 is readable by the control circuit 310, and stores a plurality of programs including a virtualization program VM and a control program PM1 executed by the control circuit 310, various types of information used by the control circuit 310, or the like. The virtualization program VM divides resources such as the control circuit 310 and the storage circuit 320 of the server 300 into a plurality of resources, and operates each of the divided resources as the cloud server CS. The head manufacturer uses some of the cloud servers CS among a plurality of cloud server CS as a part of the server 300. The control program PM1 is developed by the head manufacturer.

However, the storage circuit 320 may not have the virtualization program VM, and the processing apparatus 200 may access the server 300 instead of the cloud server CS.

The storage circuit 320 includes, for example, one or both semiconductor memories of one or more volatile memories such as a RAM and one or more non-volatile memories such as a ROM, an EEPROM, or a PROM. RAM is an abbreviation for Random Access Memory. ROM is an abbreviation for Read Only Memory. EEPROM is an abbreviation for Electrically Erasable Programmable Read-Only Memory. PROM is an abbreviation for Programmable ROM.

The communication device 380 is hardware having a communication circuit for communicating with the processing apparatus 200 via the network NW. The communication device 380 is also referred to as a network device, a network controller, a network card, or a communication module, for example.

### 1-3. Configuration of Processing Apparatus 200

FIG. 3 is a diagram illustrating a configuration of the processing apparatus 200. The processing apparatus 200 includes a control circuit 210, a storage circuit 220, a communication device 230, an input device 260, and a display device 270. The control circuit 210, the storage circuit 220, the communication device 230, the input device 260, and the display device 270 are coupled to one another via a bus 290 for communicating information.

The control circuit 210 includes, for example, a processor such as one or more CPUs. The control circuit 210 may include a programmable logic device such as an FPGA instead of or in addition to the CPU.

The storage circuit 220 is composed of a magnetic storage device, a flash ROM, or the like. The storage circuit 220 is readable by the control circuit 210, and stores a plurality of programs including an ink jet program PM2 executed by the control circuit 210, various types of information used by the control circuit 210, or the like. The storage circuit 220 includes, for example, one or both semiconductor memories of one or more volatile memories such as a RAM and one or more non-volatile memories such as a ROM, an EEPROM, or a PROM. When the processing apparatus 200 is coupled to the ink jet printer 100, the ink jet program PM2 is downloaded from the cloud server CS operating on the server 300 and installed in the processing apparatus 200, for example. The ink jet program PM2 is, for example, a program that generates the image data Img. More specifically, the ink jet program PM2 generates the image data Img indicating an image generated by the application program. The application program is, for example, an application program that creates a document and an application program that creates an image.

The communication device 230 is hardware having a communication circuit to communicate with the processing apparatus 200 via the network NW. The communication device 230 is also referred to as a network device, a network controller, a network card, or a communication module, for example.

The communication device 240 is a circuit configured to communicate with the ink jet printer 100. For example, the communication device 240 is a network card such as a USB or Bluetooth. USB is an abbreviation for Universal Serial Bus. USB and Bluetooth are registered trademarks.

The input device 260 is a device that outputs operation information according to the operation of the user U. The input device 260 is, for example, a mouse and a keyboard.

The display device 270 displays an image indicating some information to the user U. The display device 270 is an organic EL display, an LED display, and an LCD. EL is an abbreviation for Electro-Luminescence. LED is an abbreviation for Light Emitting Diode. LCD is an abbreviation for Liquid Crystal Display. In addition, a configuration in which the input device 260 and the display device 270 are integrated may be used. The configuration in which the input device 260 and the display device 270 are integrated is, for example, a touch panel.

As shown in FIGS. 1 to 3, there is a business model in which the head manufacturer provides the liquid ejecting head HU to the printer manufacturer, and the printer manufacturer manufactures the ink jet printer 100 by incorporating the liquid ejecting head HU into the printer main body. In this business model, printer manufacturers generally design and manufacture components other than the liquid ejecting head HU. In the present embodiment, the head manufacturer prepares the cloud server CS and the ink jet program PM2 that operates on the processing apparatus 200, and the user U connects the processing apparatus 200 to the cloud server CS and causes the processing apparatus 200 to operate the ink jet program PM2. As described above, in the present embodiment, since the printer manufacturer does not need to prepare the ink jet program PM2, the load of the printer manufacturer for designing and manufacturing components can be reduced.

### 1-4. Configuration of Ink Jet Printer 100

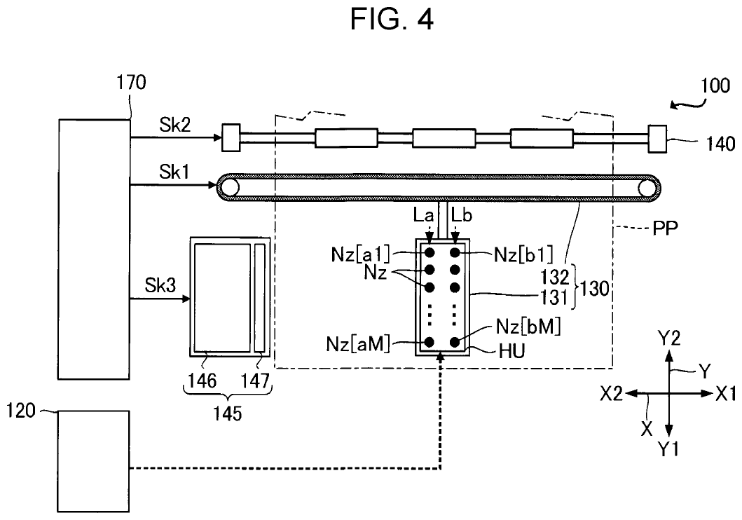

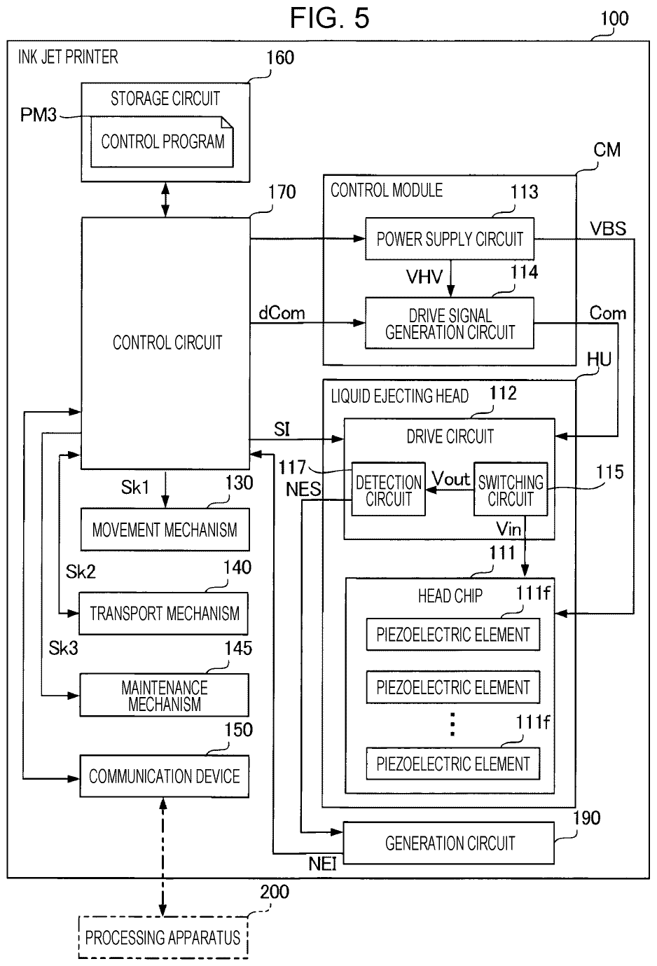

FIG. 4 is a schematic diagram illustrating an example of a configuration of the ink jet printer 100. FIG. 5 is a block diagram illustrating a configuration example of the ink jet printer 100. In the following description, an X-axis, a Y-axis, and a Z-axis which are orthogonal to each other are assumed. One direction along the X-axis when viewed from an optional point is referred to as an X1 direction, and a direction opposite to the X1 direction is referred to as an X2 direction. Similarly, directions opposite to each other along the Y-axis from an optional point are referred to as a Y1 direction and a Y2 direction, and directions opposite to each other along the Z-axis from an optional point are referred to as a Z1 direction and a Z2 direction. An X-Y plane including the X-axis and the Y-axis corresponds to a horizontal plane. The Z-axis is an axis along a vertical direction, and the Z2 direction corresponds to a downward direction in the vertical direction.

The ink jet printer 100 according to the first embodiment is a serial type printer that reciprocates the liquid ejecting head HU along the X-axis. Specifically, as shown in FIG. 4, the ink jet printer 100 according to the first embodiment executes an ejection operation of forming an image on the medium PP by ejecting ink from the nozzle Nz as the medium PP is transported in the Y1 direction, which is a sub-scanning direction, and moving the liquid ejecting head HU in the X1 direction and the X2 direction, which are main scanning directions. In FIG. 4, some nozzles Nz of a plurality of nozzles Nz included in the liquid ejecting head HU are representatively illustrated.

As illustrated in FIG. 4, the plurality of nozzles Nz included in the liquid ejecting head HU are classified into a nozzle row La and a nozzle row Lb that are arranged at intervals in the direction along the X-axis. Each of the nozzle row La and the nozzle row Lb is a set of the plurality of nozzles Nz linearly arranged in a direction along the Y-axis. In the following description, it is assumed that the number of the nozzles Nz included in the nozzle row La and the nozzle row Lb is M, which is one or more. Therefore, the number of the nozzles Nz included in the liquid ejecting head HU is 2M. In addition, in order to distinguish each of the 2M nozzles Nz, the nozzle Nz classified into the nozzle row La may be referred to as a nozzle Nz[am1], and the nozzle Nz classified into the nozzle row Lb may be referred to as a nozzle Nz[bm2]. m1 and m2 are integers of 1 or greater and M or less. In addition, in the following, the nozzle Nz[a1] to the nozzle Nz[aM] and the nozzle Nz[b1] to the nozzle Nz[bM] may be referred to as the nozzle Nz without distinction.

In the present embodiment, as illustrated in FIG. 4, among the M nozzles Nz classified into the nozzle row La, the nozzle Nz disposed furthest in the Y2 direction is referred to as the nozzle Nz[a1], and the nozzle Nz disposed furthest in the Y1 direction is referred to as the nozzle Nz[aM]. In addition, among the M nozzles Nz classified into the nozzle row Lb, the nozzle Nz disposed furthest in the Y2 direction is referred to as the nozzle Nz[b1], and the nozzle Nz disposed furthest in the Y1 direction is referred to as the nozzle Nz[bM].

As illustrated in FIGS. 4 and 5, the ink jet printer 100 includes a control module CM, the liquid ejecting head HU, a liquid container 120, a movement mechanism 130, a transport mechanism 140, a maintenance mechanism 145, a communication device 150, a storage circuit 160, and a control circuit 170.

The control module CM includes a power supply circuit 113 and a drive signal generation circuit 114. The liquid ejecting head HU is an assembly including a head chip 111 and a drive circuit 112. The liquid ejecting head HU may incorporate a part or all of the control module CM.

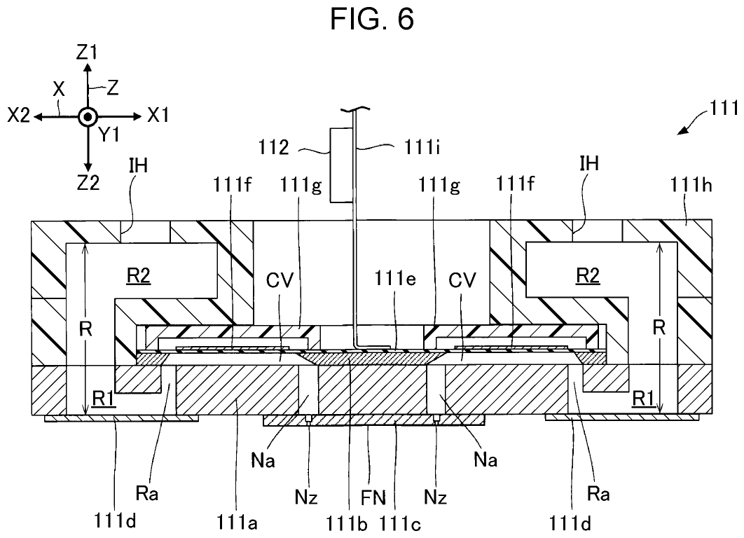

The head chip 111 ejects ink toward the medium PP. In FIG. 4, among the components of the head chip 111, 2M piezoelectric elements 111f are representatively illustrated. A detailed example of the head chip 111 will be described later with reference to FIG. 6.

In the example illustrated in FIG. 5, the number of the head chips 111 included in the liquid ejecting head HU is one, but the number may be two or more. One or more head chips 111 are disposed such that the plurality of nozzles Nz are distributed over a part of the medium PP in a width direction.

Under the control of the control circuit 170, the drive circuit 112 switches whether or not to supply a drive signal Com output from the drive signal generation circuit 114 to each of a plurality of piezoelectric elements 111f included in the head chip 111.

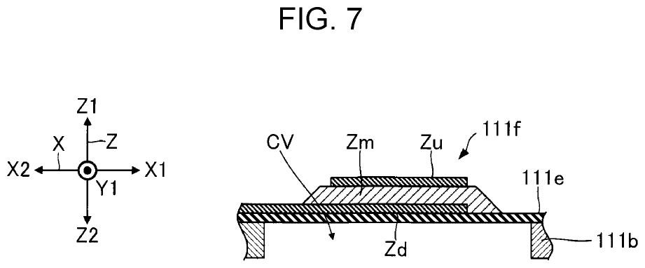

The drive circuit 112 includes a switching circuit 115 and a detection circuit 117. Under the control of the control circuit 170, the switching circuit 115 switches whether or not to supply the drive signal Com output from the drive signal generation circuit 114 to each of the 2M piezoelectric elements 111f included in the head chip 111 coupled to the drive circuit 112. In addition, the switching circuit 115 switches whether or not to electrically couple each of the piezoelectric elements 111f and the detection circuit 117. In the present embodiment, it is assumed that the drive signal Com includes a drive signal Com-A and a drive signal Com-B. Further, among the drive signals Com-A and Com-B, a signal actually supplied to the piezoelectric element 111f may be referred to as a supply drive signal Vin. The switching circuit 115 includes, for example, a group of switches such as a transmission gate for the switching. Details of the switching circuit 115 will be described later with reference to FIG. 7. The detection circuit 117 outputs a residual vibration signal NES indicating the vibration remaining in a pressure chamber CV, which will be described later, to a generation circuit 190 after the piezoelectric element 111f is driven. More specifically, the detection circuit 117 generates the residual vibration signal NES based on a detection signal Vout detected from the piezoelectric element 111f driven by the drive signal Com.

The power supply circuit 113 receives electric power from a commercial power supply (not illustrated) and generates various predetermined potentials. The generated various potentials are appropriately supplied to each section of the ink jet printer 100. In the example illustrated in FIG. 5, the power supply circuit 113 generates a power supply potential VHV and an offset potential VBS. The offset potential VBS is supplied to the head chip 111 or the like. In addition, the power supply potential VHV is supplied to the drive signal generation circuit 114 or the like.

The drive signal generation circuit 114 is a circuit that generates the drive signal Com to drive each of the piezoelectric elements 111f included in the head chip 111. Specifically, the drive signal generation circuit 114 includes, for example, a DA conversion circuit and an amplifier circuit. In the drive signal generation circuit 114, the DA conversion circuit converts a waveform designation signal dCom to be described later from the control circuit 170 from a digital signal to an analog signal, and the amplifier circuit generates the drive signal Com by amplifying the analog signal by using the power supply potential VHV from the power supply circuit 113.

As illustrated in FIG. 4, the liquid container 120 that stores ink is installed in the ink jet printer 100. For example, a cartridge that is detachably attached to the ink jet printer 100, a bag-shaped ink pack formed of a flexible film, or an ink tank that can be replenished with ink is used as the liquid container 120.

The movement mechanism 130 and the transport mechanism 140 move the relative positions of the medium PP and the liquid ejecting head HU under the control of the control circuit 170. The movement of the relative position means that the liquid ejecting head HU may be moved as the position of the medium PP is fixed, or the medium PP may be moved as the position of the liquid ejecting head HU is fixed. In the present embodiment, with respect to the direction along the X-axis that is the main scanning direction, the liquid ejecting head HU is moved in the direction along the X-axis as the position of the medium PP in the X-axis is fixed, and with respect to the Y1 direction that is the sub-scanning direction, the medium PP is moved in the Y1 direction as the position of the liquid ejecting head HU in the direction along the Y-axis is fixed.

The movement mechanism 130 causes the liquid ejecting head HU to reciprocate along the X-axis under the control of the control circuit 170. As illustrated in FIG. 4, the movement mechanism 130 includes a substantially box-shaped carriage 131 that accommodates the liquid ejecting head HU, and an endless belt 132 to which the liquid ejecting head HU is fixed. A configuration in which the liquid container 120 is mounted on the carriage 131 together with the liquid ejecting head HU can also be employed.

The transport mechanism 140 transports the medium PP in the Y1 direction under the control of the control circuit 170. Specifically, the transport mechanism 140 includes a transport roller (not illustrated) whose rotation shaft is parallel to the X-axis, and a motor (not illustrated) that rotates the transport roller under control by the control circuit 170.

The communication device 150 is a circuit configured to communicate with the processing apparatus 200. For example, the communication device 150 is a network card such as a USB or Bluetooth. In addition, the communication device 150 may be integrated with the control circuit 170.

The storage circuit 160 stores various programs including a control program PM3 executed by the control circuit 170 and various types of data such as the image data Img processed by the control circuit 170. The storage circuit 160 includes, for example, one or both semiconductor memories of one or more volatile memories such as a RAM and one or more non-volatile memories such as a ROM, an EEPROM, or a PROM. The storage circuit 160 may be configured as a portion of the control circuit 170.

The control circuit 170 has a function of controlling the operation of each section of the ink jet printer 100 and a function of processing various types of data. The control circuit 170 includes, for example, a processor such as one or more CPUs. The control circuit 170 may include a programmable logic device such as an FPGA instead of or in addition to the CPU.

The control circuit 170 controls the operation of each section of the ink jet printer 100 by executing a program stored in the storage circuit 160. Here, the control circuit 170 generates signals such as a control signal Sk1, a control signal Sk2, a control signal Sk3, a print signal SI, and the waveform designation signal dCom as signals for controlling the operation of each section of the ink jet printer 100.

The control signal Sk1 is a signal for controlling driving of the movement mechanism 130. The control signal Sk2 is a signal for controlling driving of the transport mechanism 140. The control signal Sk3 is a signal for controlling the maintenance mechanism 145. The print signal SI is a signal for controlling driving the drive circuit 112. Specifically, the print signal SI designates whether or not the drive circuit 112 supplies the drive signal Com from the drive signal generation circuit 114 to the piezoelectric element 111f for each predetermined unit period. By this designation, the amount of ink ejected from the head chip 111 or the like is designated. The waveform designation signal dCom is a digital signal for defining the waveform of the drive signal Com generated by the drive signal generation circuit 114.

When the recording processing is executed, the control circuit 170 first causes the storage circuit 160 to store the image data Img supplied from the processing apparatus 200. Next, the control circuit 170 generates various control signals such as the print signal SI, the waveform designation signal dCom, the control signal Sk1, the control signal Sk2, and the control signal Sk3 based on the image data Img stored in the storage circuit 160. The control circuit 170 controls the liquid ejecting head HU such that the piezoelectric element 111f is driven as the transport mechanism 140 and the movement mechanism 130 are controlled to change the relative position of the medium PP with respect to the liquid ejecting head HU based on various control signals and various types of data stored in the storage circuit 160. Thereby, the control circuit 170 adjusts the presence or absence of ink ejection from the piezoelectric element 111f, the ejection amount of ink, the ejection timing of ink, or the like, and controls the execution of the recording processing for forming an image based on the image data Img on the medium PP.

Further, the ink jet printer 100 according to the present embodiment may execute ejection state determination processing for determining whether the ejection state of the ink from each of the nozzles Nz is normal or abnormal. Further, when an ejection failure is generated in the nozzle Nz included in the liquid ejecting head HU, it may be referred to as the ejection failure of the liquid ejecting head HU. In addition, the nozzle Nz in which the ejection failure is generated may be referred to as an “ejection failure nozzle Nz-T”. On the other hand, the nozzle Nz in which no ejection failure is generated may be referred to as a “normal ejection nozzle Nz-S”.

Here, the ejection failure is a state in which the ink cannot be ejected in the aspect defined by the drive signal Com although the piezoelectric element 111f is driven by the drive signal Com to eject the ink from the nozzle Nz and the ejection characteristic of the nozzle Nz is lowered. The ejection characteristic is, for example, one or both of the ejection amount and the ejection speed. Causes of the ejection failure include air bubbles mixed in the ink inside the liquid ejecting head HU, thickening of the ink of the liquid ejecting head HU, adhesion of paper dust to a nozzle surface FN of the liquid ejecting head HU, which will be described later, or the like. Here, the ejection aspect of the ink defined by the drive signal Com is that the piezoelectric element 111f ejects an amount of ink defined by the waveform of the drive signal Com, and the piezoelectric element 111f ejects the ink at an ejection speed defined by the waveform of the drive signal Com. That is, a state where the ink cannot be ejected according to the ejection aspect of ink defined by the drive signal Com includes a state where an amount of ink smaller than the ejection amount of ink defined by the drive signal Com is ejected from the nozzle Nz, a state where an amount of ink greater than the ejection amount of ink defined by the drive signal Com is ejected from the nozzle Nz, a state where the ink cannot land at a desired landing position on the medium PP because the ink is ejected at a speed different from the ejection speed of ink defined by the drive signal Com, or the like, in addition to a state where the ink cannot be ejected from nozzle Nz. In the following, the nozzle Nz that is a determination target of the ejection state may be referred to as a “determination target nozzle Nz-H”.

In the ejection state determination processing, the ink jet printer 100 executes a series of processing in which firstly, the control circuit 170 selects the determination target nozzle Nz-H from the 2M nozzles Nz, secondly, by driving the determination target nozzle Nz-H under the control of the control circuit 170, residual vibration is caused to be generated in the pressure chamber CV communicating with the determination target nozzle Nz-H, thirdly, the detection circuit 117 generates a residual vibration signal NES based on the detection signal Vout detected from the piezoelectric element 111f that detects the residual vibration, and fourthly, the generation circuit 190 generates individual residual vibration information NEI related to the residual vibration based on the residual vibration signal NES.

Further, the ink jet printer 100 according to the present embodiment executes maintenance processing for recovering the ejection failure of the nozzle Nz having the ejection failure by the maintenance mechanism 145. The maintenance processing includes flushing processing for discharging ink from the nozzle Nz, wiping processing for wiping off foreign matter such as paper dust adhering to the vicinity of the nozzle Nz with a wiper 147, and pumping processing for suctioning the ink, air bubbles, or the like in the nozzle Nz with a tube pump. The flushing processing is processing for forcibly removing thickened ink and air bubbles mixed in the ink by repeatedly driving the piezoelectric element 111f by using the drive signal Com for the flushing processing. The maintenance mechanism 145 includes a cap 146 to cover the liquid ejecting head HU such that the nozzle Nz is sealed, the wiper 147, a tube pump (not illustrated) to suck the ink, air bubbles, or the like, and a discharged ink receiving section (not illustrated) for receiving the discharged ink when the ink is discharged. The maintenance mechanism 145 is provided in a region that does not overlap with the medium PP when viewed in the Z-axis direction.

FIG. 6 is a cross-sectional view illustrating a configuration example of the head chip 111. Here, in FIG. 6, the drive circuit 112 is also illustrated in addition to the head chip 111. The head chip 111 has a configuration substantially symmetrical with each other in the direction along the X-axis. However, the positions of the nozzles Nz classified into the nozzle row La and the plurality of nozzles Nz of the nozzle row Lb in the direction along the Y-axis may coincide with each other or may be different from each other. FIG. 6 illustrates a configuration in which the positions of the plurality of nozzles Nz of the nozzle row La and the plurality of nozzles Nz of the nozzle row Lb in the direction along the Y-axis coincide with each other.

As illustrated in FIG. 6, the head chip 111 includes a flow path substrate 111a, a pressure chamber substrate 111b, a nozzle plate 111c, a vibration absorbing body 111d, a vibration plate 111e, the plurality of piezoelectric elements 111f, a protective plate 111g, a case 111h, and a wiring substrate 111i.

The flow path substrate 111a and the pressure chamber substrate 111b are stacked in this order in the Z1 direction, and form a flow path for supplying ink to the plurality of nozzles Nz. The vibration plate 111e, the plurality of piezoelectric elements 111f, the protective plate 111g, the case 111h, and the wiring substrate 111i are installed in a region positioned further in the Z1 direction with respect to the stacked body formed by the flow path substrate 111a and the pressure chamber substrate 111b. On the other hand, the nozzle plate 111c and the vibration absorbing bodies 111d are installed in a region positioned further in the Z2 direction with respect to the stacked body. Each element of the head chip 111 is schematically a plate-shaped member elongated in the Y direction, and is joined to each other by, for example, an adhesive. Hereinafter, each element of the head chip 111 will be described in order.

The nozzle plate 111c is a plate-shaped member provided with the plurality of nozzles Nz of each of the nozzle row La and the nozzle row Lb. Each of the plurality of nozzles Nz is a through hole through which ink passes. Here, the surface of the nozzle plate 111c facing the Z2 direction is the nozzle surface FN. The nozzle plate 111c is manufactured by processing a silicon single crystal substrate by a semiconductor manufacturing technique using a processing technique such as dry etching or wet etching. Here, other known methods and materials may be appropriately used for manufacturing the nozzle plate 111c. In addition, although the cross-sectional shape of the nozzle Nz is typically circular, the shape is not limited thereto and may be, for example, a non-circular shape such as polygonal and elliptical shapes.

A space R1, a plurality of supply flow paths Ra, and a plurality of communication flow paths Na are provided in the flow path substrate 111a for each of the nozzle row La and the nozzle row Lb. The space R1 is an elongated opening extending in the direction along the Y-axis in a plan view in the direction along the Z-axis. Each of the supply flow path Ra and the communication flow path Na is a through hole formed for each nozzle Nz. Each of the supply flow paths Ra communicates with the space R1.

The pressure chamber substrate 111b is a plate-shaped member in which a plurality of pressure chambers CV called cavities are provided for each of the nozzle row La and the nozzle row Lb. The plurality of pressure chambers CV are arranged in the direction along the Y-axis. Each pressure chamber CV is an elongated space formed for each nozzle Nz and extending in the direction along the X-axis in a plan view. Each of the flow path substrate 111a and the pressure chamber substrate 111b is manufactured by processing a silicon single crystal substrate by a semiconductor manufacturing technique, for example, in the same manner as the nozzle plate 111c described above. Here, other known methods and materials may be appropriately used for the manufacturing of each of the flow path substrate 111a and the pressure chamber substrate 111b.

The pressure chamber CV is a space positioned between the flow path substrate 111a and the vibration plate 111e. The plurality of pressure chambers CV are arranged in the direction along the Y-axis for each of the nozzle row La and the nozzle row Lb. In addition, the pressure chamber CV communicates with each of the communication flow path Na and the supply flow path Ra. Therefore, the pressure chamber CV communicates with the nozzle Nz through the communication flow path Na and communicates with the space R1 through the supply flow path Ra.

The vibration plate 111e is disposed on a surface of the pressure chamber substrate 111b facing the Z1 direction. The vibration plate 111e is a plate-shaped member that can elastically vibrate. The vibration plate 111e has, for example, a first layer and a second layer, which are stacked in the Z1 direction in this order. The first layer is, for example, an elastic film made of a silicon oxide (SiO₂). For example, the elastic film is formed by thermally oxidizing one surface of a silicon single crystal substrate. The second layer is, for example, an insulating film made of a zirconium oxide (ZrO₂). The insulating film is formed, for example, by forming a zirconium layer by a sputtering method and thermally oxidizing the layer. The vibration plate 111e is not limited to the above-mentioned stacked configuration of the first layer and the second layer, and may be composed of, for example, a single layer or three or more layers.

The plurality of piezoelectric elements 111f mutually corresponding to the nozzles Nz are disposed on a surface of the vibration plate 111e facing the Z1 direction for each of the nozzle row La and the nozzle row Lb. Each of the piezoelectric elements 111f is a passive element deformed by the drive signal Com being supplied. Each of the piezoelectric elements 111f has an elongated shape extending in the direction along the X-axis in a plan view. The plurality of piezoelectric elements 111f are arranged in the direction along the Y-axis to correspond to the plurality of pressure chambers CV. The piezoelectric element 111f overlaps the pressure chamber CV in a plan view.

FIG. 7 is an enlarged cross-sectional view illustrating the vicinity of the piezoelectric element 111f. However, in FIG. 7, the protective plate 111g is not illustrated such that the drawing is not complicated.

As illustrated in FIG. 7, the piezoelectric element 111f is a stacked body in which a piezoelectric body Zm is interposed between an upper electrode Zu to which the offset potential VBS is supplied and a lower electrode Zd to which the drive signal Com is supplied. The piezoelectric element 111f is, for example, a portion where the lower electrode Zd, the upper electrode Zu, and the piezoelectric body Zm overlap when viewed in the Z1 direction. In addition, the pressure chamber CV is provided in the Z2 direction of the piezoelectric element 111f. In the first embodiment, there is an aspect in which the offset potential VBS is supplied to the upper electrode Zu and the drive signal Com is supplied to the lower electrode Zd, but there may be an aspect in which the drive signal Com may be supplied to the upper electrode Zu, and the offset potential VBS may be supplied to the lower electrode Zd.

In the first embodiment, the lower electrode Zd is an individual electrode that is disposed to be separated from each other for each piezoelectric element 111f. On the other hand, the upper electrode Zu is a band-shaped common electrode that extends in the direction along the Y-axis to be continuous over the plurality of piezoelectric elements 111f. Examples of the metal material of the lower electrode Zd and the upper electrode Zu include metal materials such as platinum (Pt), aluminum (Al), nickel (Ni), gold (Au), and copper (Cu), and among these, one type can be used alone, or two or more types can be used in combination in an aspect of alloy or stacking or the like.

The piezoelectric body Zm is made of a piezoelectric material such as lead zirconate titanate (Pb(Zr, Ti)O₃) and, for example, has a band shape extending in the direction along the Y-axis to be continuous over the plurality of piezoelectric elements 111f. However, the piezoelectric body Zm may be integrated over the plurality of piezoelectric elements 111f. In this case, the piezoelectric body Zm is provided with through holes extending in the direction along the X-axis, penetrating through the piezoelectric layer in regions corresponding to the gaps between the respective pressure chambers CV adjacent to each other in a plan view. When the vibration plate 111e vibrates in conjunction with the above deformation of the piezoelectric elements 111f, the pressure in the pressure chamber CV fluctuates, and ink is ejected from the nozzle Nz.

The description returns to FIG. 6. The protective plate 111g is a plate-shaped member installed on the surface of the vibration plate 111e facing the Z1 direction, and protects the plurality of piezoelectric elements 111f and reinforces the mechanical strength of the vibration plate 111e. Here, the plurality of piezoelectric elements 111f are accommodated between the protective plate 111g and the vibration plate 111e. The protective plates 111g are made of, for example, a resin material.

The case 111h is a member for storing ink supplied to the plurality of pressure chambers CV. The case 111h is made of, for example, a resin material. The case 111h is provided with a space R2 for each of the nozzle row La and the nozzle row Lb. The space R2 is a space that communicates with the space R1 described above, and functions as a reservoir R for storing the ink supplied to the plurality of pressure chambers CV together with the space R1. The case 111h is provided with an introduction port IH for supplying ink to each of the reservoirs R. The ink in each of the reservoirs R is supplied to the pressure chamber CV through each of the supply flow paths Ra.

The vibration absorbing body 111d, also referred to as a compliance substrate, is a flexible resin film constituting a wall surface of the reservoir R, and absorbs pressure fluctuations of ink in the reservoir R. The vibration absorbing body 111d may be a thin plate made of metal and having flexibility. The surface of the vibration absorbing body 111d facing the Z1 direction is joined to the flow path substrate 111a with an adhesive or the like.

The wiring substrate 111i is mounted on the surface of the vibration plate 111e facing the Z1 direction, and is a mounting component for electrically coupling the head chip 111, the drive circuit 112, the control module CM, or the like. The wiring substrate 111i is, for example, a flexible wiring substrate such as COF, FPC, or FFC. The drive circuit 112 described above is mounted on the wiring substrate 111i of the present embodiment. COF is an abbreviation for Chip On Film. FPC is an abbreviation for Flexible Printed Circuit. FFC is an abbreviation for Flexible Flat Cable.

In the following, when it is assumed that n1 is a or b and m1 is any integer from 1 to M, the element related to the nozzle Nz[n1m1] may be described by adding [n1m1]. For example, the pressure chamber CV communicating with the nozzle Nz[n1m1] may be referred to as a pressure chamber CV[n1m1], and the piezoelectric element 111f that applies pressure to the pressure chamber CV[n1m1] may be referred to as a piezoelectric element 111f[n1m1]. Similarly, the elements related to the determination target nozzle Nz-H may be described by adding “-H”. For example, the pressure chamber CV communicating with the determination target nozzle Nz-H may be referred to as a “determination target pressure chamber CV-H”, and the piezoelectric element 111f that applies pressure to the determination target pressure chamber CV-H may be referred to as a “determination target piezoelectric element 111f-H”.

### 1-5. Configuration of Liquid Ejecting Head HU

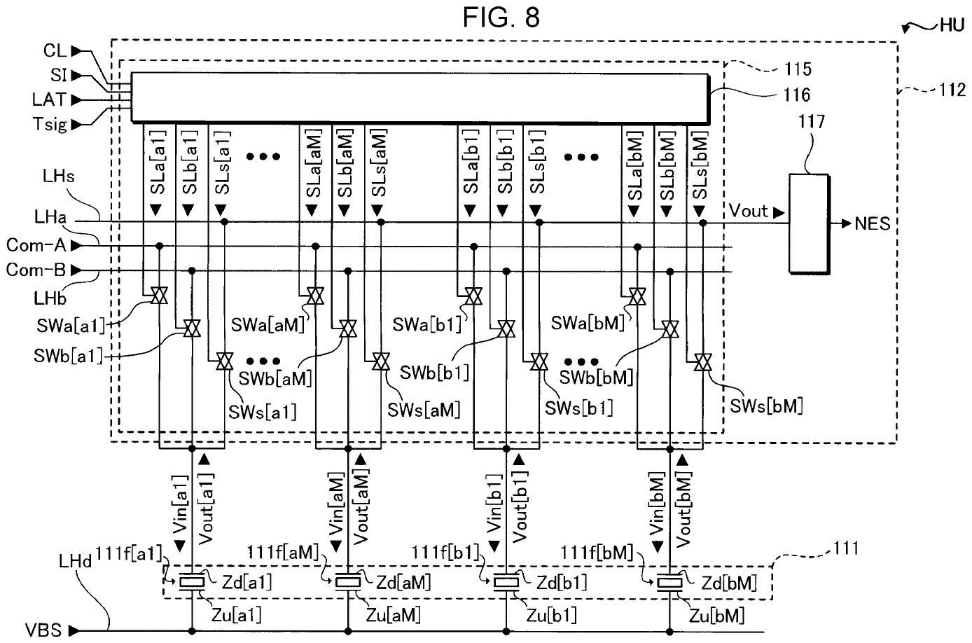

Hereinafter, a configuration of the liquid ejecting head HU will be described with reference to FIG. 8.

FIG. 8 is a block diagram illustrating an example of the configuration of the liquid ejecting head HU. FIG. 8 illustrates the head chip 111 and the drive circuit 112 provided in the liquid ejecting head HU.

In addition to the head chip 111 and the drive circuit 112, the liquid ejecting head HU includes an internal wiring LHa to which the drive signal Com-A is supplied from the drive signal generation circuit 114, an internal wiring LHb to which the drive signal Com-B is supplied from the drive signal generation circuit 114, an internal wiring LHs for supplying the detection signal Vout detected from the piezoelectric element 111f to the detection circuit 117, and an internal wiring LHd supplied with the offset potential VBS.

As illustrated in FIG. 8, the switching circuit 115 includes 2M switches SWa[a1] to SWa[bM], 2M switches SWb[a1] to SWb[bM], 2M switches SWs[a1] to SWs[bM], and a coupling state designation circuit 116 that designates the coupling state of each switch. As each switch, for example, a transmission gate can be employed.

The coupling state designation circuit 116 generates coupling state designation signals SLa[a1] to SLa[bM] for designating ON/OFF of the switches SWa[a1] to SWa[bM], coupling state designation signals SLb[a1] to SLb[bM] for designating ON/OFF of the switches SWb[a1] to SWb[bM], and coupling state designation signals SLs[a1] to SLs[bM] for designating ON/OFF of the switches SWs[a1] to SWs[bM] based on at least some of the print signal SI, a latch signal LAT, and a period designation signal Tsig supplied from the control circuit 170.

When n1 is a or b and m1 is any integer from 1 to M, the switch SWa[n1m1] switches conduction and non-conduction between the internal wiring LHa and the lower electrode Zd[n1m1] of the piezoelectric element 111f[n1m1] according to a coupling state designation signal SLa[n1m1]. For example, the switch SWa[n1m1] turns on when the coupling state designation signal SLa[n1m1] is at a high level, and turns off when it is at a low level.

When n1 is a or b and m1 is any integer from 1 to M, the switch SWb[n1m1] switches conduction and non-conduction between the internal wiring LHb and the lower electrode Zd[n1m1] of the piezoelectric element 111f[n1m1] according to the coupling state designation signal SLb[n1m1]. For example, the switch SWb[n1m1] turns on when the coupling state designation signal SLb[n1m1] is at a high level, and turns off when it is at a low level.

When n1 is a or b and m1 is any integer from 1 to M, a switch SWs[n1m1] switches conduction and non-conduction between the internal wiring LHs and the lower electrode Zd[n1m1] of the piezoelectric element 111f[n1m1] according to the coupling state designation signal SLs[n1m1]. For example, the switch SWs[n1m1] turns on when the coupling state designation signal SLs[n1m1] is at a high level, and turns off when it is at a low level.

When n1 is a or b and m1 is any integer from 1 to M, the detection circuit 117 is supplied with a detection signal Vout[n1m1] output from the piezoelectric element 111f[n1m1] through the internal wiring LHs. Thereafter, the detection circuit 117 generates the residual vibration signal NES based on the detection signal Vout[n1m1]. The residual vibration signal NES is an analog signal.

The detection circuit 117 may be configured to include, for example, a negative feedback type amplifier for amplifying the detection signal Vout, a low-pass filter for attenuating the high frequency component of the detection signal Vout, and a voltage follower that converts impedance and outputs the residual vibration signal NES having a low impedance.

The generation circuit 190 generates the individual residual vibration information NEI related to the residual vibration based on the residual vibration signal NES. The individual residual vibration information NEI is a digital signal. For example, the generation circuit 190 samples the residual vibration signal NES at regular intervals, and generates information in which the time information indicating the time of sampling based on any start point and the value indicating the potential obtained by sampling are associated with each other, as the individual residual vibration information NEI.

### 1-6. Operation of Liquid Ejecting Head HU

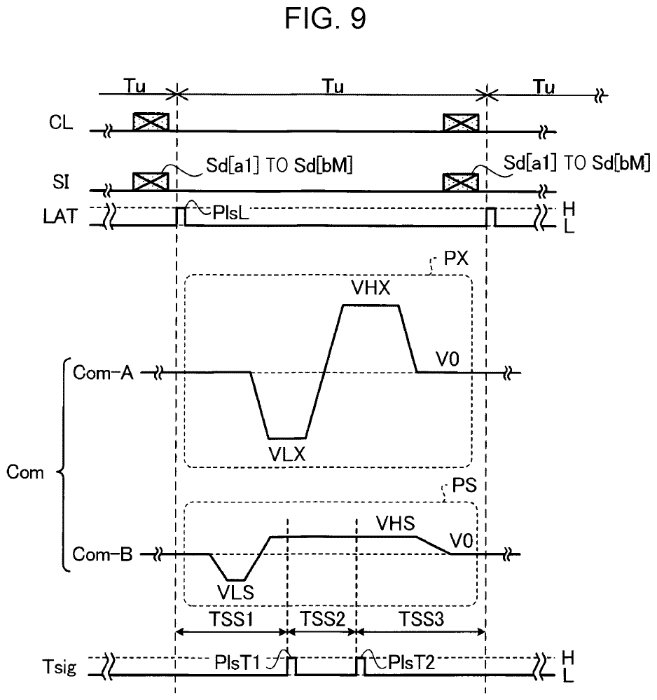

Hereinafter, the operation of the liquid ejecting head HU will be described with reference to FIG. 9. In the present embodiment, an operating period of the ink jet printer 100 includes one or more recording periods Tu. It is assumed that, in each of the recording periods Tu, the ink jet printer 100 according to the present embodiment executes one of the driving of each of the piezoelectric elements 111f in the recording processing and the driving of the determination target piezoelectric element 111f-H and the detection of the residual vibration in preparation processing of the ejection state determination processing. However, the present disclosure is not limited to such an aspect, and in each of the recording periods Tu, both the driving of each of the piezoelectric elements 111f in the recording processing and the driving of the determination target piezoelectric element 111f-H and the detection of the residual vibration in the preparation processing of the ejection state determination processing may be configured to be executed.

In general, the ink jet printer 100 forms an image based on the image data Img by ejecting the ink one or a plurality of times from each of the nozzles Nz over a plurality of continuous or intermittent recording periods Tu. In addition, in the 2M recording periods Tu provided continuously or intermittently, the ink jet printer 100 according to the present embodiment executes the ejection state determination processing in which each of the 2M nozzles Nz[a1] to Nz[bM] is defined as the determination target nozzle Nz-H by executing the preparation processing of the ejection state determination processing 2M times.

FIG. 9 is a timing chart for describing an operation of the ink jet printer 100 in the recording period Tu. As illustrated in FIG. 9, the control circuit 170 outputs the latch signal LAT having a pulse PlsL. Thereby, the control circuit 170 defines the recording period Tu as the period from the rise of the pulse PlsL to the rise of the next pulse PlsL.

The print signal SI includes individual designation signals Sd[a1] to Sd[bM] that designate the driving aspects of the piezoelectric elements 111f[a1] to 111f[bM] in each of the recording periods Tu. Then, when at least one of the recording processing and the ejection state determination processing is executed in the recording period Tu, as illustrated in FIG. 9, the control circuit 170 synchronizes the print signal SI including the individual designation signals Sd[a1] to Sd[bM] with a clock signal CL prior to the start of the recording period Tu and supplies the print signal SI to the coupling state designation circuit 116. In this case, when n1 is a or b and m1 is any integer from 1 to M, the coupling state designation circuit 116 generates the coupling state designation signals SLa[n1m1], SLb[n1m1], and SLs[n1m1] based on the individual designation signal Sd[n1m1] in the recording period Tu.

When n1 is a or b and m1 is any integer from 1 to M, the individual designation signal Sd[n1m1] according to the present embodiment is a signal that designates any one of the three driving aspects of ejection of ink, non-ejection of ink, and driving as a determination target in the ejection state determination processing, with respect to the piezoelectric element 111f[n1m1], in each of the recording periods Tu.

As illustrated in FIG. 9, the drive signal generation circuit 114 outputs the drive signal Com-A having an ejection waveform PX. The ejection waveform PX has a lowest potential VLX and a highest potential VHX. Potentials at the start and the end of the ejection waveform PX are set to a reference potential V0.

Then, on the assumption that n1 is a or b and m1 is any integer from 1 to M, when the individual designation signal Sd[n1m1] designates the ejection of ink for the piezoelectric element 111f[n1m1], the coupling state designation circuit 116 sets the coupling state designation signal SLa[n1m1] to a high level in the recording period Tu, and sets the coupling state designation signals SLb[n1m1] and SLs[n1m1] to a low level in the recording period Tu. In this case, the nozzle Nz[n1m1] ejects the ink in the recording period Tu, and dots are formed on the medium PP.

As illustrated in FIG. 9, the drive signal generation circuit 114 outputs the drive signal Com-B having an inspection waveform PS provided in the recording period Tu. In the present embodiment, the inspection waveform PS is defined such that the potential difference between a highest potential VHS and a lowest potential VLS of the inspection waveform PS is smaller than the potential difference between the highest potential VHX and the lowest potential VLX of the ejection waveform PX. Specifically, on the assumption that n1 is a or b and m1 is any integer from 1 to M, when the drive signal Com-B having the inspection waveform PS is supplied to the piezoelectric element 111f[n1m1], the inspection waveform PS is defined such that the piezoelectric element 111f[n1m1] is driven to such an extent that ink is not ejected from the nozzle Nz[n1m1]. Potentials at the start and end of the inspection waveform PS are set to the reference potential V0.

In addition, the control circuit 170 outputs the period designation signal Tsig having a pulse PlsT1 and a pulse PlsT2. Thereby, the control circuit 170 classifies the recording period Tu into a control period TSS1 from the start of the pulse PlsL to the start of the pulse PlsT1, a control period TSS2 from the start of the pulse PlsT1 to the start of the pulse PlsT2, and a control period TSS3 from the start of the pulse PlsT2 to the start of the next pulse PlsL.

Then, on the assumption that n1 is a or b and m1 is any integer from 1 to M, when the individual designation signal Sd[n1m1] designates the nozzle Nz[n1m1] as the determination target nozzle Nz-H, the coupling state designation circuit 116 sets the coupling state designation signal SLa[n1m1] to a low level in the recording period Tu, sets the coupling state designation signal SLb[n1m1] to a high level in the control periods TSS1 and TSS3 and to a low level in the control period TSS2, respectively, and sets the coupling state designation signal SLs[n1m1] to a low level in the control period TSS1 and the control period TSS3 and to a high level in the control period TSS2, respectively.

In this case, the determination target piezoelectric element 111f-H is driven by the drive signal Com-B having the inspection waveform PS in the control period TSS1. The piezoelectric element 111f is displaced by the drive signal Com-B having the inspection waveform PS in the control period TSS1. As a result, vibration is generated in the determination target pressure chamber CV-H, and this vibration remains even in the control period TSS2. In the control period TSS2, the lower electrode Zd included in the determination target piezoelectric element 111f-H changes the potential according to the residual vibration generated in the determination target pressure chamber CV-H. In other words, in the control period TSS2, the lower electrode Zd included in the determination target piezoelectric element 111f-H indicates a potential corresponding to the electromotive force of the piezoelectric element 111f caused by the residual vibration generated in the determination target pressure chamber CV-H. The potential of the lower electrode Zd can be detected as the detection signal Vout in the control period TSS2.

### 1-7. Cause of Ejection Failure

As described above, the cause of the ejection failure is the mixing of air bubbles, the thickening of the ink, and the adhesion of paper dust, but it is found by the experiment or the like of the inventor that the ejection failure may be caused by other than the above. Specifically, it is found that droplets slightly overflow from the nozzle Nz due to a reason such as insufficient wiping processing or insufficient setting of the negative pressure of the pressure chamber CV, resulting in the formation of liquid pool on the nozzle surface FN, and the liquid pool may slightly adversely affect the ejection characteristics. Hereinafter, the nozzle Nz having the ejection characteristics deteriorated by the generation of the liquid pool may be referred to as a liquid pool generation nozzle Nz-M.

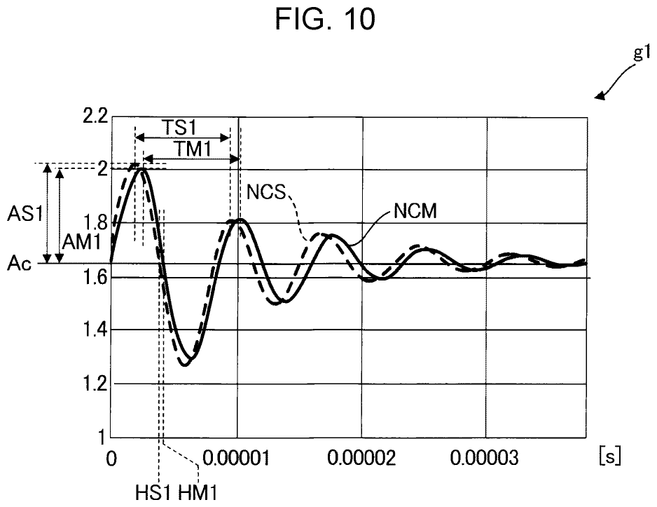

When an attempt is made to detect the presence or absence of the generation of the liquid pool using the residual vibration, it is found that the residual vibration with respect to the liquid pool generation nozzle Nz-M is slightly different from the residual vibration for the normal ejection nozzle Nz-S. This difference will be described with reference to FIG. 10.

FIG. 10 is a diagram for describing the residual vibration with respect to the liquid pool generation nozzle Nz-M. A graph g1 illustrated in FIG. 10 illustrates the characteristics of the residual vibration of the liquid pool generation nozzle Nz-M and the normal ejection nozzle Nz-S. The horizontal axis of the graph g1 indicates the time, and the vertical axis of the graph g1 indicates the potential. A residual vibration characteristic NCS illustrated in the graph g1 indicates the characteristic of the residual vibration with respect to the normal ejection nozzle Nz-S. A residual vibration characteristic NCM illustrated in the graph g1 indicates the characteristic of the residual vibration with respect to the liquid pool generation nozzle Nz-M.

As illustrated in the residual vibration characteristic NCM and the residual vibration characteristic NCS of FIG. 10, an amplitude AM1 of the residual vibration with respect to the liquid pool generation nozzle Nz-M is slightly smaller than an amplitude AS1 of the residual vibration with respect to the normal ejection nozzle Nz-S. The amplitude AM1 and the amplitude AS1 are absolute values of differences between the potential of the first extreme value of the residual vibration and a potential Ac of the center of the amplitude of the residual vibration. In addition, a period TM1 of the residual vibration with respect to the liquid pool generation nozzle Nz-M is slightly longer than a period TS1 of the residual vibration with respect to the normal ejection nozzle Nz-S. The period TM1 and the period TS1 are periods from the first extreme value to the third extreme value of the residual vibration. In addition, the time HM1 at which the residual vibration with respect to the liquid pool generation nozzle Nz-M is at the center of the amplitude is slightly later than time HS1 at which the residual vibration with respect to the normal ejection nozzle Nz-S is at the center of the amplitude. The time HM1 and the time HS1 are the first times when the residual vibration is at the center of the amplitude. The fact that the residual vibration is at the center of the amplitude is when the phase of the residual vibration is 0 degrees or 180 degrees, assuming that the residual vibration is a sine wave in which the amplitude is attenuated.

As described above, as illustrated by the residual vibration characteristic NCM and the residual vibration characteristic NCS, there is a difference between the residual vibration with respect to the liquid pool generation nozzle Nz-M and the residual vibration with respect to the normal ejection nozzle Nz-S, but it is difficult to distinguish the difference from an error range because the difference is small, and whether or not the liquid pool is generated cannot be accurately detected although the residual vibration with respect to the one nozzle Nz is used. Here, the liquid pool is not generated only in the one nozzle Nz, but is generated over a plurality of adjacent nozzles Nz. Since the nozzle Nz has a very small size and the liquid pool is spread to a certain extent by the surface tension, the liquid pool formed due to a certain nozzle Nz ends up covering the adjacent nozzle Nz. That is, when the liquid pool is generated, the residual vibration of the one liquid pool generation nozzle Nz-M cannot be distinguished from the error range, but it is found by the experiment or the like of the inventor that the same tendency of deviation is generated in the residual vibration of the plurality of adjacent nozzles Nz. In the present embodiment, it is determined whether or not the liquid pool is generated by using the fact that the same tendency of deviation is generated in the residual vibration of the plurality of adjacent nozzles Nz.

In the following description, the abnormality in which the liquid pool is formed may be referred to as a “liquid pool formation abnormality”, and among the abnormalities that causes the ejection failure, an abnormality of the liquid ejecting head HU, which is an abnormality other than the liquid pool formation abnormality, such as the mixing of air bubbles, the thickening of the ink, and the adhesion of paper dust may be referred to as a “pre-existing head abnormality”. The liquid pool formation abnormality is an example of a “first abnormality”, and the pre-existing head abnormality is an example of a “second abnormality”.

### 1-8. Functions and Operations of Ink Jet System 10

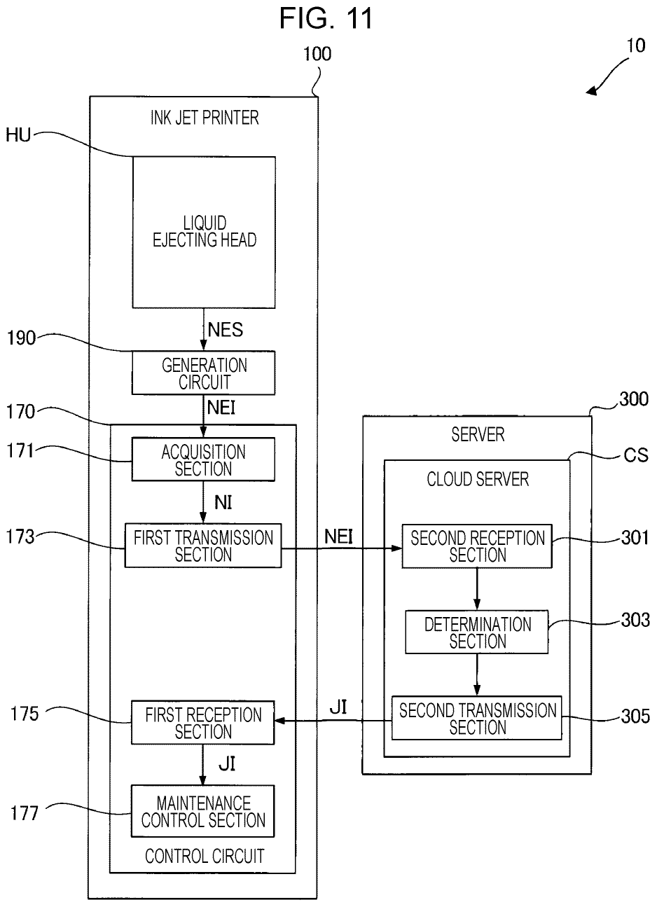

Functions and operations of the ink jet system 10 will be described with reference to FIGS. 11 to 15. In the present embodiment, the cloud server CS executes abnormality determination processing and provides the ink jet printer 100 with the service of providing determination information JI indicating a determination result. The abnormality determination processing is the processing of determining whether it is the liquid pool formation abnormality, the pre-existing head abnormality, or normal ejection in which the liquid pool formation abnormality and the pre-existing head abnormality are not present, based on residual vibration information NI. The residual vibration information NI has 2M pieces of the individual residual vibration information NEI.

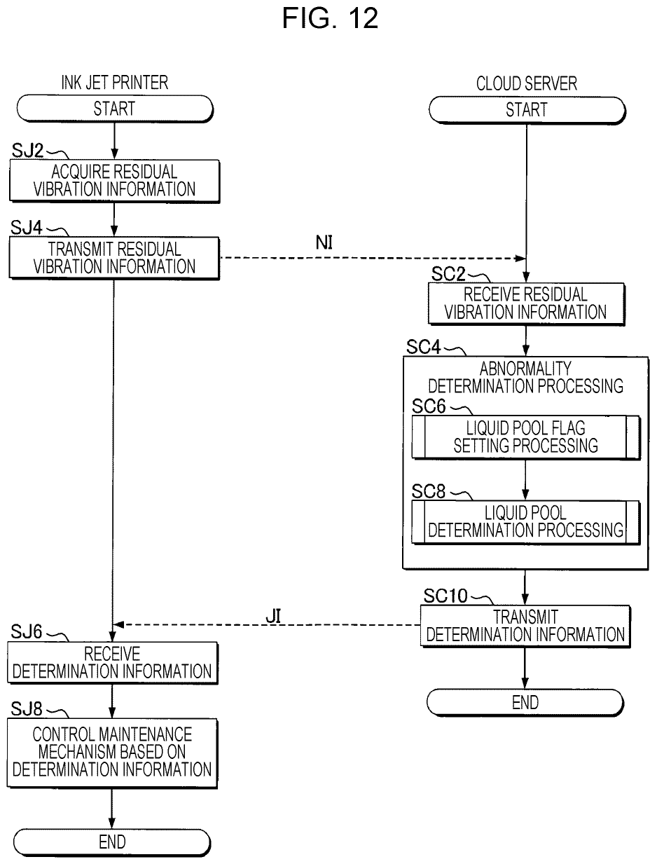

FIG. 11 is a diagram illustrating functions of the ink jet system 10. FIG. 12 is a flowchart illustrating operations of the ink jet system 10. The control circuit 170 functions as an acquisition section 171, a first transmission section 173, a first reception section 175, and a maintenance control section 177 by reading the control program PM3 and executing the read control program PM3. The server 300 reads the virtualization program VM and executes the read virtualization program VM to function as the cloud server CS. The cloud server CS reads the control program PM1 and executes the control program PM1 to function as a second reception section 301, a determination section 303, and a second transmission section 305.

The flowchart illustrated in FIG. 12 is executed, for example, when the ink jet printer 100 receives the image data Img from the processing apparatus 200, before the recording processing is executed. In a step SJ2, the control circuit 170 functions as the acquisition section 171 and acquires the residual vibration information NI. Specifically, the control circuit 170 acquires 2M pieces of the individual residual vibration information NEI corresponding to the 2M nozzles Nz, which are to be included in the residual vibration information NI, from the generation circuit 190. More specifically, the control circuit 170 sets the nozzle Nz[x] as the determination target nozzle Nz-H in each of x from a1 to bM, and executes the ejection state determination processing with respect to the determination target nozzle Nz-H to acquire the individual residual vibration information NEI[x]. The step SJ2 is an example of an “acquisition step”. After the processing of the step SJ2 is ended, in a step SJ4, the control circuit 170 functions as the first transmission section 173, controls the communication device 150, and transmits the residual vibration information NI having 2M pieces of the individual residual vibration information NEI acquired by the acquisition section 171 to the cloud server CS. More specifically, the first transmission section 173 transmits the residual vibration information NI to the cloud server CS via the processing apparatus 200. The step SJ4 is an example of a “transmission step”. After the processing of the step SJ4 is ended, the control circuit 170 waits for a response from the cloud server CS.

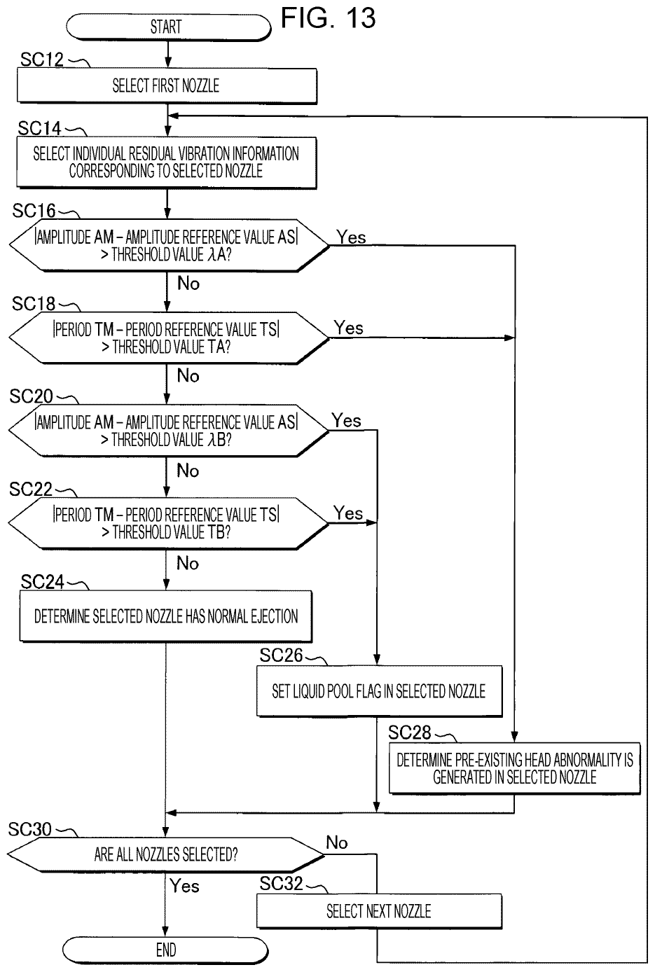

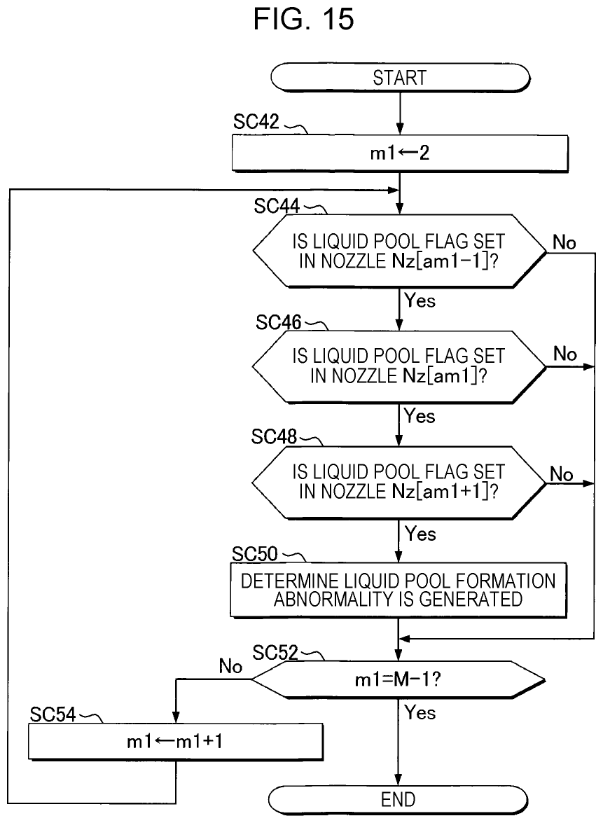

In a step SC2, the cloud server CS functions as the second reception section 301, and the cloud server CS receives the residual vibration information NI from the ink jet printer 100. After the processing of the step SC2 is ended, in a step SC4, the cloud server CS functions as the determination section 303 and executes the abnormality determination processing. The step SC4 is an example of a “determination step”. As illustrated in FIG. 12, the abnormality determination processing includes liquid pool flag setting processing, which is processing of a step SC6, and liquid pool determination processing, which is processing of a step SC8. The liquid pool flag setting processing will be described with reference to FIG. 13, and the liquid pool determination processing will be described with reference to FIG. 15.

FIG. 13 is a flowchart illustrating the liquid pool flag setting processing. The liquid pool flag setting processing is processing of setting a liquid pool flag for the nozzle Nz in which the ejection characteristic may be lowered due to the liquid pool. However, the nozzle Nz in which the liquid pool flag is set may have normal ejection. In addition, the liquid pool flag setting processing also determines whether or not the pre-existing head abnormality is present. In addition, in the series of processing illustrated in FIG. 13, the determination section 303 determines the nozzle Nz in which the ejection characteristic may be lowered due to the liquid pool by using the amplitude of the residual vibration and the period of the residual vibration.

In a step SC12, the determination section 303 selects the first nozzle Nz among the 2M nozzles Nz. The first nozzle Nz among the 2M nozzles Nz may be any one of the nozzles Nz among the 2M nozzles Nz, but in the present embodiment, it is assumed to be the nozzle Nz[a1].

After the processing of the step SC12 is ended, in a step SC14, the determination section 303 selects the individual residual vibration information NEI corresponding to the selected nozzle Nz among 2M pieces of the individual residual vibration information NEI included in the residual vibration information NI. In a step SC16, the determination section 303 determines whether or not the following expression (1) is established by using the selected individual residual vibration information NEI.

$$\vert amplitude AM - amplitude reference value AS \vert > threshold value λ A \qquad ( 1 )$$

However, |x|means an absolute value of x. The amplitude AM is an absolute value of a difference between the potential of the first extreme value of the residual vibration of the selected individual residual vibration information NEI and the potential of the center of the amplitude of the residual vibration. The amplitude reference value AS is an absolute value of a difference between the potential of the first extreme value of the residual vibration with respect to the normal ejection nozzle Nz-S and the potential of the center of the amplitude of the residual vibration. The threshold value λA is a threshold value of amplitude for determining whether or not the pre-existing head abnormality is present. The amplitude reference value AS and the threshold value λA are set in advance by an experiment or experience of the head manufacturer. The head manufacturer stores the amplitude reference value AS and the threshold value λA in the storage circuit 320.

When the determination result in the step SC16 is negative, the determination section 303 determines whether or not the following expression (2) is established by using the selected individual residual vibration information NEI in a step SC18.

$$\vert period TM - period reference value TS \vert > threshold value TA \qquad ( 2 )$$

The period TM is a period from the first extreme value to the third extreme value of the residual vibration of the selected individual residual vibration information NEI. The period reference value TS is a period from the first extreme value to the third extreme value of the residual vibration with respect to the normal ejection nozzle Nz-S. The threshold value TA is a threshold value for the period for determining whether or not the pre-existing head abnormality is present. The period reference value TS and the threshold value TA are set in advance by an experiment or experience of the head manufacturer. The head manufacturer stores the period reference value TS and the threshold value TA in the storage circuit 320.

When the determination result in the step SC18 is negative, the determination section 303 determines whether or not the following expression (3) is established by using the selected individual residual vibration information NEI in a step SC20.

$$\vert amplitude AM - amplitude reference value AS \vert > threshold value λ B \qquad ( 3 )$$

The threshold value λB is a threshold value of amplitude for determining whether or not the ejection characteristic may be lowered by the liquid pool. The threshold value λB is set in advance by an experiment or experience of the head manufacturer. The head manufacturer stores the threshold value λB in the storage circuit 320. The threshold value λB is smaller than the threshold value λA. For example, the threshold value λB may be equal to or less than 1/10 of the threshold value λA, or may be equal to or less than 1/100 of the threshold value λA. After the description of the processing of a step SC28, the relationship between the threshold value λA and the threshold value λB will be described.

When the determination result in the step SC20 is negative, the determination section 303 determines whether or not the following expression (4) is established by using the selected individual residual vibration information NEI in a step SC22.

$$\vert period TM - period reference value TS \vert > threshold value TB \qquad ( 4 )$$

The threshold value TB is a threshold value for a period for determining whether or not the ejection characteristic may be lowered by the liquid pool. The threshold value TB is set in advance by an experiment or experience of the head manufacturer. The head manufacturer stores the threshold value TB in the storage circuit 320. For example, the threshold value TB may be equal to or less than 1/10 of the threshold value TA, or may be equal to or less than 1/100 of the threshold value TA.

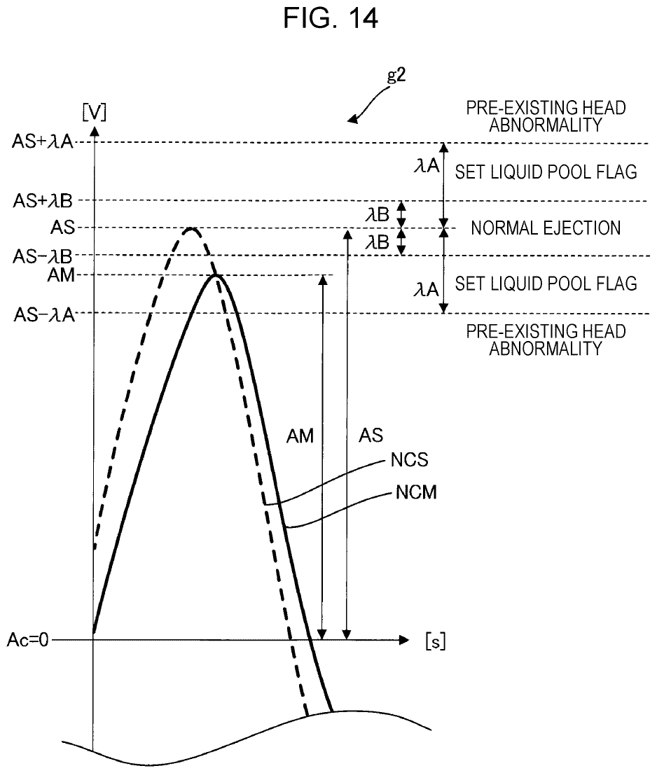

When the determination result in the step SC22 is negative, the determination section 303 determines that the selected nozzle Nz has normal ejection in a step SC24. In addition, when the determination result in the step SC20 is positive or when the determination result in the step SC22 is positive, the determination section 303 sets the liquid pool flag in the selected nozzle Nz in a step SC26. Specifically, the determination section 303 associates the information for identifying the selected nozzle Nz with the liquid pool flag and stores the information in the storage circuit 320. In addition, when the determination result in the step SC16 is positive or when the determination result in the step SC18 is positive, the determination section 303 determines that the pre-existing head abnormality is generated in the selected nozzle Nz in a step SC28. Although not illustrated, the determination section 303 determines any of the mixing of air bubbles, the thickening of ink, and the adhesion of paper dust from the selected individual residual vibration information NEI by a known method. A relationship between the threshold value λA and the threshold value λB will be described with reference to FIG. 14.

FIG. 14 is a diagram for describing a relationship between the threshold value λA and the threshold value λB. A graph g2 illustrated in FIG. 14 is an enlarged diagram of the vicinity of the first extreme value of the residual vibration in the graph g1. However, the graph g2 illustrates the potential Ac at the center of the amplitude of the residual vibration as 0 [V] for easy understanding. Further, in the graph g2, in order to align the description with the description of the expression (1) and the expression (3) illustrated in FIG. 13, the absolute value of the difference between the potential of the first extreme value of the residual vibration with respect to the liquid pool generation nozzle Nz-M and the potential Ac of the center of the amplitude of the residual vibration is referred to as the amplitude AM, and the absolute value of the difference between the potential of the first extreme value of the residual vibration with respect to the normal ejection nozzle Nz-S and the potential Ac of the center of the amplitude of the residual vibration is referred to as the amplitude reference value AS.

With respect to the amplitude of the residual vibration, a case where the selected nozzle Nz is determined to have the pre-existing head abnormality is a case where the expression (1) is established. When the expression (1) is established, as can be understood from FIG. 14, either one of the following expression (1-a) or expression (1-b) is established.

$$amplitude AM > amplitude reference value AS + threshold value λ A \qquad ( 1 - a )$$

$$amplitude AM < amplitude reference value AS - threshold value λ A \qquad ( 1 - b )$$

In addition, a case where the liquid pool flag is set in the selected nozzle Nz is a case where the expression (1) is not established and the expression (3) is established. A case where the expression (1) is not established and the expression (3) is established, as can be understood from FIG. 14, is a case where either one of the following expression (3-a) or expression (3-b) is established.

$$amplitude reference value AS + threshold value + λ B < amplitude AM \leq amplitude reference value AS + threshold value λ A \qquad ( 3 - a )$$

$$amplitude reference value AS - threshold value + λ A \leq amplitude AM < amplitude reference value AS - threshold value λ B \qquad ( 3 - b )$$

As indicated by the expression (3-a) and the expression (3-b), in the first embodiment, when the liquid pool is generated in the selected nozzle Nz, the fact that the amplitude AM of the residual vibration with respect to the selected nozzle Nz may be greater than the amplitude reference value AS+the threshold value λB and the fact that the amplitude AM may be smaller than the amplitude reference value AS−the threshold value λB are considered.

In addition, a case where the selected nozzle Nz has normal ejection is a case where the expression (3) is not established. A case where the expression (3) is not established, as can be understood from FIG. 14, is a case where the following expression (3-c) is established.

$$amplitude reference value AS - threshold value λ B \leq amplitude AM \leq amplitude reference value AS + threshold value λ B \qquad ( 3 - c )$$

As can be understood from FIG. 14, since the threshold value λB is smaller than the threshold value λA, the amplitude reference value AS−the threshold value λA is smaller than the amplitude reference value AS−the threshold value λB. The amplitude reference value AS−the threshold value λA is an example of a “second threshold value”, and the amplitude reference value AS−the threshold value λB is an example of a “first threshold value”.

In the example of FIG. 14, since the expression (3-b) is established, the determination section 303 sets the liquid pool flag in the selected nozzle Nz.

Although not illustrated, the relationship between the threshold value TA and the threshold value TB is the same as the relationship between the threshold value λA and the threshold value λB. Specifically, with respect to the period of the residual vibration, a case where the selected nozzle Nz is determined to have the pre-existing head abnormality is a case where the expression (2) is established. A case where the expression (2) is established is a case where either one of the following expression (2-a) or expression (2-b) is established.

$$period TM > period reference value TS + threshold value TA \qquad ( 2 - a )$$

$$period TM < period reference value TS - threshold value TA \qquad ( 2 - b )$$

In addition, a case where the liquid pool flag is set in the selected nozzle Nz is a case where the expression (2) is not established and the expression (4) is established. A case where the expression (2) is not established and the expression (4) is established is a case where either one of the following expression (4-a) or expression (4-b) is established.

$$period reference value TS + threshold value TB < period TM \leq period reference value TS + threshold value TA \qquad ( 4 - a )$$

$$period reference value TS - threshold value TA \leq period TM < period reference value TS - threshold value TB \qquad ( 4 - b )$$

As indicated by the expression (4-a) and the expression (4-b), in the first embodiment, when the liquid pool is generated in the selected nozzle Nz, the fact that the period TM of the residual vibration with respect to the selected nozzle Nz may be longer than the period reference value TS+the threshold value TB and the fact that the period TM may be shorter than the period reference value TS−the threshold value TB are considered.

A case where the selected nozzle Nz has normal ejection is a case where the expression (4) is not established. A case where the expression (4) is not established is a case where the following expression (4-c) is established.

$$period reference value TS - threshold value TB \leq period TM \leq period reference value TS + threshold value TB \qquad ( 4 - c )$$

Since the threshold value TB is smaller than the threshold value TA, the period reference value TS+the threshold value TA is longer than the period reference value TS+the threshold value TB. The period reference value TS+the threshold value TA is an example of a “fourth threshold value”, and the period reference value TS+the threshold value TB is an example of a “third threshold value”.

The description will return to FIG. 13. After the processing of the step SC24, the processing of the step SC26, or the processing of the step SC28 is ended, the determination section 303 determines whether or not all the nozzles Nz are selected in a step SC30. When the determination result in the step SC30 is negative, the determination section 303 selects the next nozzle Nz in a step SC32. In the present embodiment, the next nozzle Nz is the nozzle Nz adjacent to the selected nozzle Nz in the Y1 direction. Specifically, when n1 is either a or b and m1 is an integer from 1 to M−1, the next nozzle Nz is the nozzle Nz[n1m1+1] when the selected nozzle Nz is the nozzle Nz[n1m1]. However, when the selected nozzle Nz is the nozzle Nz[aM], the next nozzle Nz is the nozzle Nz[b1]. After the processing of the step SC32 is ended, the determination section 303 returns the processing to the step SC14. When the determination result in the step SC30 is positive, the determination section 303 ends the series of processing illustrated in FIG. 13.

In the flowchart illustrated in FIG. 13, as the amplitude of the residual vibration, the absolute value of the difference between the potential of the first extreme value of the residual vibration and the potential of the center of the amplitude of the residual vibration is used, but the present disclosure is not limited thereto. For example, the amplitude of the residual vibration may be the absolute value of the difference between the potential of the second or subsequent extreme value of the residual vibration and the potential of the center of the amplitude of the residual vibration. However, since the amplitude of the residual vibration is attenuated with the passage of time, the absolute value of the difference between the potential of the first extreme value of the residual vibration and the potential of the center of the amplitude of the residual vibration is greater than the absolute value of the difference between the potential of the second or subsequent extreme value of the residual vibration and the potential of the center of the amplitude of the residual vibration. Therefore, by using the potential of the first extreme value of the residual vibration, the influence of noise is relatively reduced as compared with the case of using the potential of the second or subsequent extreme value of the residual vibration, so that the measurement accuracy of the amplitude of the residual vibration can be improved.

In addition, in the flowchart illustrated in FIG. 13, the period from the first extreme value to the third extreme value of the residual vibration is used as the period of the residual vibration, but the present disclosure is not limited thereto. For example, the period of the residual vibration may be a period from the n-th extreme value to the (n+2)-th extreme value of the second or subsequent time. Further, the period of the residual vibration may be used without using the extreme value of the residual vibration. Since the period of the sine wave is a period from a time of any phase to a time of the same phase again, for example, the period may be a period from the n-th time (1 or greater) at which the residual vibration is at the center of the amplitude to the (n+2)-th time at which the residual vibration is at the center of the amplitude. Due to the fact that the amplitude of the residual vibration uses the first or subsequent extreme value of the residual vibration, it is preferable not to use the extreme value of the residual vibration as the period of the residual vibration. When noise affects the extreme value of the residual vibration, this is because the noise affects not only the amplitude of the residual vibration, but also the period of the residual vibration.

FIG. 15 is a flowchart illustrating the liquid pool determination processing. The flowchart illustrated in FIG. 15 illustrates the liquid pool determination processing for the M nozzles Nz classified into the nozzle row La. The liquid pool determination processing for the M nozzles Nz classified into the nozzle row Lb is omitted from illustration and description, because the nozzle Nz[am1] in the flowchart illustrated in FIG. 15 only needs to be replaced with the nozzle Nz[bm1]. In addition, in the flowchart illustrated in FIG. 15, the determination section 303 determines that the liquid pool formation abnormality is generated when the liquid pool flag is set in the three continuous nozzles Nz.

In a step SC42, the determination section 303 substitutes 2 for the variable m1. Next, in a step SC44, the determination section 303 determines whether or not the liquid pool flag is set in the nozzle Nz[am1−1]. When the determination result in the step SC44 is positive, the determination section 303 determines whether or not the liquid pool flag is set in the nozzle Nz[am1] in a step SC46. When the determination result in the step SC46 is positive, the determination section 303 determines whether or not the liquid pool flag is set in the nozzle Nz[am1+1] in a step SC48.

When the determination result in the step SC48 is positive, the determination section 303 determines that the liquid pool formation abnormality is generated in a step SC50. After the processing of the step SC50 is ended, the determination section 303 determines whether or not the value of the variable m1 is M−1, which is the number of the nozzles Nz classified into the nozzle row La in a step SC52. When the determination result in the step SC44 is negative, the determination result in the step SC46 is negative, or the determination result in the step SC48 is negative, the determination section 303 executes the processing in the step SC52.

As can be understood from the processing of the step SC44 to the step SC48, although the liquid pool flag is set in the nozzle Nz[am1], when the liquid pool flag is not set in at least one of the nozzle Nz[am1−1] or the nozzle Nz[am1+1], the determination section 303 does not determine that the liquid pool formation abnormality is generated in the nozzle Nz[am1].

When the determination result in the step SC52 is negative, the determination section 303 substitutes a value obtained by adding 1 to the value of the variable m1 into the variable m1 in a step SC54. After the processing of the step SC54 is ended, the determination section 303 returns the processing to the step SC44. When the determination result in the step SC52 is positive, the determination section 303 ends the series of processing illustrated in FIG. 15.

To put the processing of FIG. 13 and the processing of FIG. 15 in other words, when the nozzle Nz[am1] is the target nozzle Nz, the nozzle Nz[am1−1] and the nozzle Nz[am1+1] are the adjacent nozzles Nz adjacent to the nozzle Nz[am1], and can also be said to be the peripheral nozzles Nz positioned around the nozzle Nz[am1]. The peripheral nozzle Nz of the nozzle Nz[am1] is, for example, the nozzle Nz included in a range of a predetermined distance set by the head manufacturer. For example, the head manufacturer measures the shape of the liquid pool by an experiment or the like, and generates a program for executing a series of processing illustrated in FIG. 15 using the nozzle Nz that is likely to be included in the liquid pool as the peripheral nozzle Nz when the target nozzle Nz is included in the liquid pool. The number of the peripheral nozzles Nz is not limited to two, and the at least one peripheral nozzle Nz may be provided.

When the amplitude of the residual vibration related to the individual residual vibration information NEI with respect to the nozzle Nz[am1] is smaller than the amplitude reference value AS−the threshold value λB, and the amplitude of the residual vibration related to the individual residual vibration information NEI with respect to the nozzle Nz[am1−1] and the nozzle Nz[am1+1] is smaller than the amplitude reference value AS−the threshold value λB, the determination section 303 determines that the liquid pool formation abnormality is generated. The nozzle Nz[am1] is an example of the “target nozzle”, and the individual residual vibration information NEI with respect to the nozzle Nz[am1] is an example of “first individual information related to residual vibration in the pressure chamber communicating with the target nozzle”. The nozzle Nz[am 1−1] and the nozzle Nz[am 1+1] are examples of the “adjacent nozzle” and the “peripheral nozzle”, the individual residual vibration information NEI with respect to the nozzle Nz[am1−1] and the individual residual vibration information NEI with respect to the nozzle Nz[am1+1] are examples of “second individual information related to the residual vibration in the pressure chamber CV communicating with the peripheral nozzle Nz”.

In the series of processing illustrated in FIG. 15, the determination section 303 determines that the liquid pool formation abnormality is generated when the liquid pool flags are set in the three continuous nozzles Nz, but the number of the continuous nozzles Nz is not limited to three, and may be two or more. For example, the determination section 303 may determine that the liquid pool formation abnormality is generated when the liquid pool flag is set in the five continuous nozzles Nz. For example, when m1 is any integer of 3 or greater and M−2 or less, when the liquid pool flags are set for all of the nozzle Nz[am1−2], the nozzle Nz[am1−1], the nozzle Nz[am1], the nozzle Nz[am1+1], and the nozzle Nz[am1+2], it may be determined that the liquid pool formation abnormality is generated. In this case, the nozzle Nz[am1] is an example of the “target nozzle”, the nozzle Nz[am1−1] and the nozzle Nz[am1+1] are examples of the “adjacent nozzle” and the “peripheral nozzle”, and the nozzle Nz[am1−2] and the nozzle Nz[am1+2] are examples of the “peripheral nozzle”.

Further, in the series of processing illustrated in FIG. 15, the determination section 303 determines that the liquid pool formation abnormality is generated when the liquid pool flag is set in the three continuous nozzles Nz, but it does not have to be the two or more continuous nozzles Nz, and it may also be determined that the liquid pool formation abnormality is generated when the liquid pool flag is set in the nozzle Nz that is the peripheral nozzle Nz of the target nozzle Nz excluding the adjacent nozzle Nz. For example, when m1 is any integer of 3 or greater and M−2 or less, and the liquid pool flags are set for all of the nozzle Nz[am1−2], the nozzle Nz[am1], and the nozzle Nz[am1+2], the determination section 303 may determine that the liquid pool formation abnormality is generated.

Further, in the series of processing illustrated in FIG. 15, the determination section 303 determines that the liquid pool formation abnormality is generated when the liquid pool flags are set in the continuous nozzles Nz in the direction along the Y-axis, but the present disclosure is not limited thereto. For example, the peripheral nozzle Nz may include the nozzle Nz adjacent to the target nozzle Nz in the direction along the X-axis. In the present embodiment, when m1 is any integer of 1 or greater and M or less, the nozzle Nz adjacent to the nozzle Nz[am1] in the direction along the X-axis is the nozzle Nz[bm1]. For example, the determination section 303 may determine that the liquid pool formation abnormality is generated when m1 is any integer of 1 or greater and M or less and the liquid pool flags are set for both the nozzle Nz[am1] and the nozzle Nz[bm1]. Alternatively, when m1 is any integer of 2 or greater and M−1 or less and the liquid pool flags are set for both the nozzle Nz[am1−1], the nozzle Nz[am1], the nozzle Nz[am1+1], and the nozzle Nz[bm1], the determination section 303 may determine that the liquid pool formation abnormality is generated.

The description will now return to FIGS. 11 and 12. After the processing of the step SC4 is ended, in a step SC10, the cloud server CS functions as the second transmission section 305 and transmits the determination information JI indicating the determination result of the determination section 303 to the ink jet printer 100. The determination information JI includes one or more identifiers among a first identifier indicating the normal ejection, a second identifier indicating that the pre-existing head abnormality is generated, and a third identifier indicating that the liquid pool formation abnormality is generated. For example, in the series of processing illustrated in FIG. 13, when it is not determined that the pre-existing head abnormality is generated and it is not determined that the liquid pool formation abnormality is generated in the series of processing illustrated in FIG. 15, the determination information JI includes the first identifier. In addition, in the series of processing illustrated in FIG. 13, when it is determined that the pre-existing head abnormality is generated, the determination information JI includes the second identifier. In addition, in the series of processing illustrated in FIG. 13, when it is determined that the liquid pool formation abnormality is generated in the series of processing illustrated in FIG. 15, the determination information JI includes the third identifier. Further, when the determination information JI includes the second identifier, the determination information JI includes an identifier indicating any of the mixing of air bubbles, the thickening of ink, and the adhesion of paper dust. After the processing of the step SC10 is ended, the cloud server CS ends the series of processing illustrated in FIG. 12.

After the processing of the step SC10 is ended, the cloud server CS may store the determination information JI in the storage circuit 320. The head manufacturer can improve the liquid ejecting head HU by analyzing the determination information JI. In addition, in order to more efficiently improve the liquid ejecting head HU by the head manufacturer, the cloud server CS may store the residual vibration information NI and the determination information JI in association with each other in the storage circuit 320. Further, in order to reduce the usage capacity of the storage circuit 320, the cloud server CS may store the residual vibration information NI and the determination information JI in the storage circuit 320 in association with each other only when the determination information JI includes one or more identifiers among the second identifier and the third identifier.

After the processing of the step SJ4 is ended, the control circuit 170 waits for a response from the cloud server CS, and in a step SJ6, the control circuit 170 functions as the first reception section 175 to receive the determination information JI from the cloud server CS. The step SJ6 is an example of a “reception step”. After the processing of the step SJ6 is ended, in a step SJ8, the control circuit 170 functions as the maintenance control section 177, and controls the maintenance mechanism 145 based on the determination information JI to eliminate the pre-existing head abnormality.

For example, when the determination information JI includes an identifier indicating the mixing of air bubbles, the maintenance control section 177 causes the maintenance mechanism 145 to execute the pumping processing. In addition, when the determination information JI includes an identifier indicating the thickening of the ink, the maintenance control section 177 causes the maintenance mechanism 145 to execute the flushing processing or the pumping processing. In addition, when the determination information JI includes an identifier indicating the adhesion of the paper dust, the maintenance control section 177 causes the maintenance mechanism 145 to execute the wiping processing. In addition, when the determination information JI includes the third identifier, the maintenance control section 177 causes the maintenance mechanism 145 to execute the wiping processing. After the processing in the step SJ8 is ended, the control circuit 170 ends a series of processing illustrated in FIG. 12.

### 1-9. Summary of First Embodiment

Hereinafter, in order to facilitate understanding, the amplitude reference value AS−the threshold value λB, which is an example of the “first threshold value” used for determining the liquid pool formation abnormality, is referred to as a “first lower limit amplitude threshold value”, and the amplitude reference value AS−the threshold value λA, which is an example of the “second threshold value” used for determining the pre-existing head abnormality, is referred to as a “second lower limit amplitude threshold value”. In addition, the individual residual vibration information NEI related to the residual vibration in the pressure chamber CV communicating with the target nozzle Nz is referred to as the “first individual information”, and the individual residual vibration information NEI related to the residual vibration in the pressure chamber CV communicating with the at least one peripheral nozzle Nz positioned around the target nozzle Nz is referred to as the “second individual information”. Further, the period reference value TS+the threshold value TB, which is an example of the “third threshold value” used for determining the liquid pool formation abnormality, is referred to as a “first upper limit period threshold value”, and the period reference value TS+the threshold value TA, which is an example of the “fourth threshold value” used for determining the pre-existing head abnormality, is referred to as the “second upper limit period threshold value”, to describe the summary of the first embodiment.

As described above, in the first embodiment, a control method of the ink jet printer 100 that includes the liquid ejecting head HU having the 2M piezoelectric elements 111 f, the 2M pressure chambers CV applying pressure to the internal ink by respectively driving the 2M piezoelectric elements 111f, and the plurality of nozzles Nz which respectively communicates with the 2M pressure chambers CV and from which the ink is ejected, and that ejects the ink onto the medium PP, is defined. This control method performs the processing of the step SJ2 of acquiring the residual vibration information NI having 2M pieces of the individual residual vibration information NEI in the pressure chambers CV after the voltage is applied to the 2M piezoelectric elements 111f and the processing of the step SC4 of determining whether or not the liquid pool formation abnormality is generated based on the residual vibration information NI.

According to the first embodiment, it can be accurately determined whether or not the liquid pool formation abnormality is generated by using the fact that the same tendency of deviation is generated in the residual vibration of the plurality of nozzles Nz. When the determination accuracy of the liquid pool formation abnormality is lowered, for example, when it is erroneously determined that the liquid pool formation abnormality is generated although the liquid pool is not actually formed, the recording processing is delayed by the unnecessary wiping processing, and the liquid repellent film provided on the nozzle surface FN may be worn or peeled off by the excessive wiping processing. When the liquid repellent film is worn or peeled off, droplets are likely to adhere to the nozzle surface, and there is a possibility that the ejection performance deteriorates. On the other hand, when it is erroneously determined that the liquid pool formation abnormality is not generated although the liquid pool is actually formed, the recording processing is executed as the liquid pool is formed, and the quality of the image formed on the medium PP is lowered.

In addition, the residual vibration information NI has first individual information and second individual information. Then, the determination section 303 determines whether or not the liquid pool formation abnormality is generated based on the first individual information and the second individual information in the step SC4.

As described above, when the ejection characteristic of the target nozzle Nz is lowered by the liquid pool, the liquid pool is spread to a certain extent by the surface tension, so that the liquid pool may also adversely affect the peripheral nozzle Nz. Therefore, according to the first embodiment, the determination accuracy of whether or not the liquid pool formation abnormality is generated can be improved as compared with the aspect of determining whether or not the liquid pool formation abnormality is generated without using the second individual information.

In addition, the peripheral nozzle Nz includes the adjacent nozzle Nz adjacent to the target nozzle Nz.

As described above, when the ejection characteristic of the target nozzle Nz is lowered by the liquid pool, the liquid pool is spread to a certain extent by the surface tension, so that the liquid pool may also adversely affect the adjacent nozzle Nz. Further, it can be said that the fact that the liquid pool may adversely affect the adjacent nozzle Nz is more likely than the fact that the liquid pool may adversely affect the nozzle Nz, which is the peripheral nozzle Nz but not the adjacent nozzle Nz. Therefore, according to the first embodiment, the determination accuracy of whether or not the liquid pool formation abnormality is generated can be improved as compared with the aspect of determining whether or not the liquid pool formation abnormality is generated without using the individual residual vibration information NEI with respect to the adjacent nozzle Nz.

In addition, in the step SC4, the determination section 303 further determines whether or not the pre-existing head abnormality is generated based on the first individual information.

According to the first embodiment, it can be accurately determined whether or not the liquid pool formation abnormality is generated as whether or not the pre-existing head abnormality is generated is determined.

In addition, in the step SC4, when the amplitude of the residual vibration related to the first individual information is smaller than the first lower limit amplitude threshold value and the amplitude of the residual vibration related to the second individual information is smaller than the first lower limit amplitude threshold value, the determination section 303 determines that the liquid pool formation abnormality is generated.

According to the first embodiment, it can be accurately determined whether or not the liquid pool formation abnormality is generated by using the amplitude of the residual vibration and the first lower limit amplitude threshold value.

In addition, in the step SC4, when the amplitude of the residual vibration related to the first individual information or the second individual information is greater than the first lower limit amplitude threshold value, the determination section 303 determines that the liquid pool formation abnormality and the pre-existing head abnormality are not generated.

For example, although the amplitude of the residual vibration with respect to the target nozzle Nz is smaller than the first lower limit amplitude threshold value, when the amplitude of the residual vibration with respect to the peripheral nozzle Nz is greater than the first lower limit amplitude threshold value, it is highly likely that the liquid pool is not generated and that the amplitude of the residual vibration with respect to the target nozzle Nz is smaller than the first lower limit amplitude threshold value due to an error such as noise. Therefore, according to the first embodiment, although the amplitude of the residual vibration of one of the first individual information or the second individual information is affected by noise, it can be correctly determined that the liquid pool formation abnormality and the pre-existing head abnormality are not generated.

In addition, in the step SC4, when the amplitude of the residual vibration related to the first individual information is smaller than the second lower limit amplitude threshold value, the determination section 303 determines that the pre-existing head abnormality is generated, and the second lower limit amplitude threshold value is smaller than the first lower limit amplitude threshold value.

According to the first embodiment, it can be determined that the pre-existing head abnormality is generated when the amplitude of the residual vibration related to the target individual residual vibration information NEI is greatly decreased and is smaller than the second lower limit amplitude threshold value.

In addition, in the step SC4, when the period of the residual vibration related to the first individual information is longer than the first upper limit period threshold value and the amplitude of the residual vibration related to the second individual information is longer than the first upper limit period threshold value, the determination section 303 determines that the liquid pool formation abnormality is generated.

According to the first embodiment, it can be accurately determined whether or not the liquid pool formation abnormality is generated by using the period of the residual vibration and the first upper limit period threshold value.

In addition, in the step SC4, when the period of the residual vibration related to the first individual information or the second individual information is shorter than the first upper limit period threshold value, the determination section 303 determines that the liquid pool formation abnormality and the pre-existing head abnormality are not generated.

According to the first embodiment, although the period of the residual vibration of one of the first individual information and the second individual information is affected by noise, it can be accurately determined that the liquid pool formation abnormality and the pre-existing head abnormality are not generated.

In addition, in the step SC4, when the period of the residual vibration related to the first individual information is longer than the second upper limit period threshold value, the determination section 303 determines that the pre-existing head abnormality is generated, and the second upper limit period threshold value is longer than the first upper limit period threshold value.

According to the first embodiment, when the period of the residual vibration related to the first individual information is lengthened and is longer than the second upper limit period threshold value, it can be determined that the pre-existing head abnormality is generated.

In addition, the control method of the ink jet printer 100 uses the cloud server CS provided outside the ink jet printer 100. The control method performs the processing of the step SJ4 of transmitting the residual vibration information NI acquired by the processing of the step SJ2 from the ink jet printer 100 to the cloud server CS and the processing of the step SJ6 of receiving the determination information JI indicating the determination result by the determination section 303 from the cloud server CS, and the cloud server CS performs the processing of the step SC4 as the determination section 303. In other words, the cloud server CS executes the abnormality determination processing and provides the ink jet printer 100 with the service that provides the determination information JI indicating the determination result.

The service that provides the determination information JI may be provided for a limited period. In addition, an aspect in which the ink jet printer 100 performs the abnormality determination processing is also possible. Therefore, as an aspect of providing the service that provides the determination information JI to the printer manufacturer for a limited period, an aspect is considered in which the ink jet printer 100 performs the abnormality determination processing. However, in the aspect in which the ink jet printer 100 performs the abnormality determination processing, the program for performing the abnormality determination processing is stored in the storage circuit 160, so that as a result of the printer manufacturer improperly analyzing the program for performing the abnormality determination processing, there is a risk that the printer manufacturer independently realizes the abnormality determination processing by using the improperly analyzed result after the period in which the service that provides the determination information JI is provided is expired. In the first embodiment, since the main body that executes the abnormality determination processing is the cloud server CS, the leakage of the program for executing the abnormality determination processing can be suppressed as the service that provides the determination information JI to the printer manufacturer is provided for a limited period.

### 2. Second Embodiment

In the first embodiment, as indicated by the expression (3-a) and the expression (3-b), when the liquid pool is generated in the selected nozzle Nz, the fact that the amplitude AM of the residual vibration with respect to the selected nozzle Nz may be greater than the amplitude reference value AS+the threshold value λB and the fact that the amplitude AM may be smaller than the amplitude reference value AS−the threshold value λB are considered. However, as illustrated in FIG. 10, the amplitude of the residual vibration with respect to the liquid pool generation nozzle Nz-M is slightly smaller than the amplitude of the residual vibration with respect to the normal ejection nozzle Nz-S. Therefore, when the liquid pool is generated in the selected nozzle Nz, only the fact that the amplitude AM of the residual vibration with respect to the selected nozzle Nz may be smaller than the amplitude reference value AS−the threshold value λB can be considered. Similarly, as indicated by the expression (4-a) and the expression (4-b), in the first embodiment, when the liquid pool is generated in the selected nozzle Nz, the fact that the period TM of the residual vibration with respect to the selected nozzle Nz may be longer than the period reference value TS+the threshold value TB and the fact that the period TM may be shorter than the period reference value TS−the threshold value TB are considered. However, as illustrated in FIG. 10, the period of the residual vibration with respect to the liquid pool generation nozzle Nz-M is slightly longer than the period of the residual vibration with respect to the normal ejection nozzle Nz-S. Therefore, when the liquid pool is generated in the selected nozzle Nz, only the fact that the period TM of the residual vibration with respect to the selected nozzle Nz may be longer than the period reference value TS+the threshold value TB can be considered. Hereinafter, the second embodiment will be described.

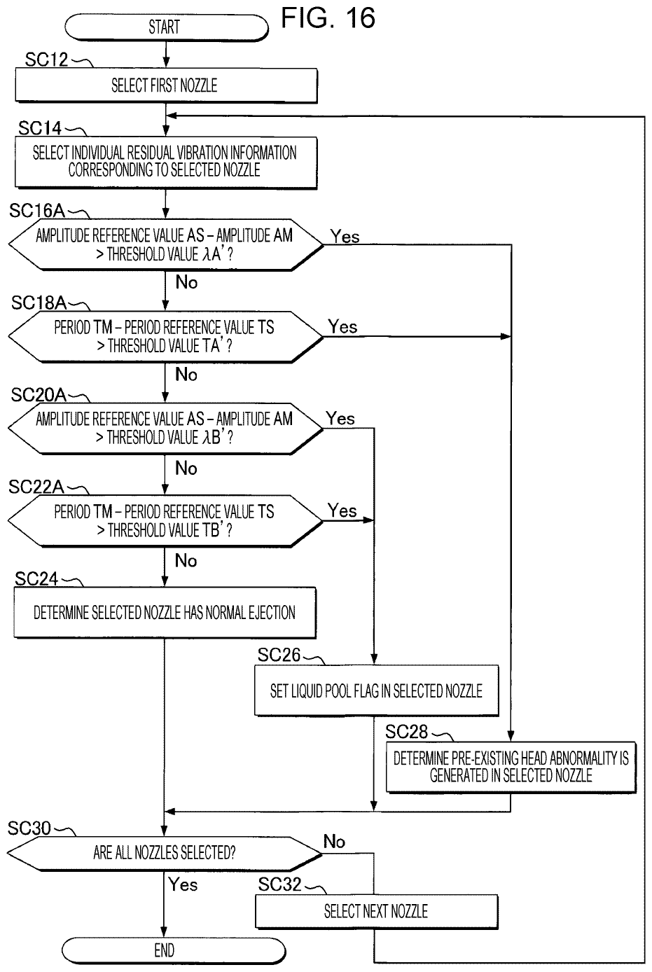

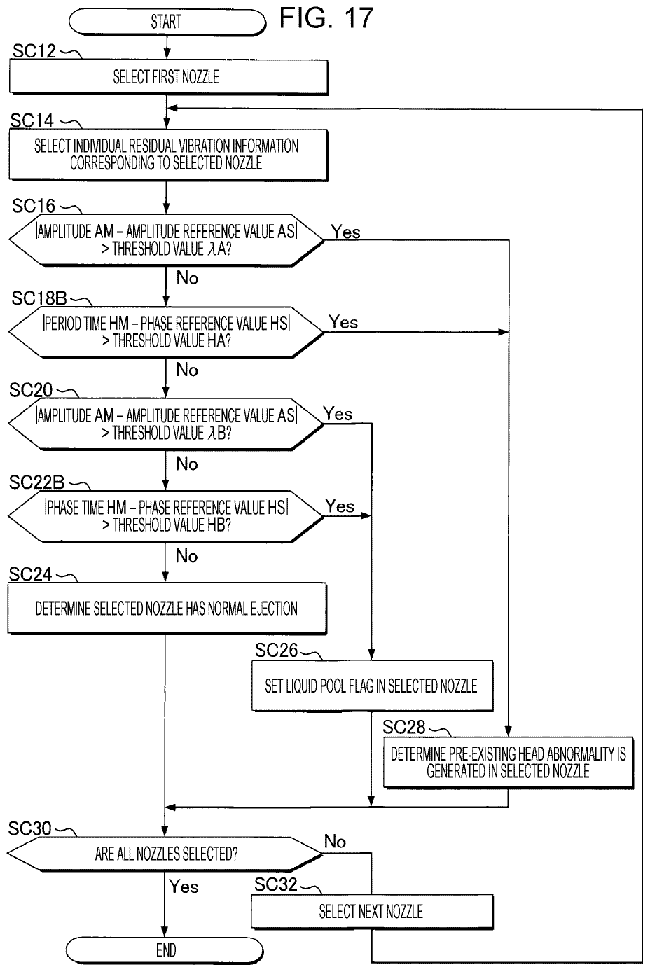

FIG. 16 is a flowchart illustrating liquid pool flag setting processing according to the second embodiment. The flowchart illustrated in FIG. 16 is different from the flowchart illustrated in FIG. 13 in that a step SC16A is performed instead of the step SC16, a step SC18A is performed instead of the step SC18, a step SC20A is performed instead of the step SC20, and a step SC22A is performed instead of the step SC22, and is the same as the flowchart illustrated in FIG. 13 in other respects. Hereinafter, only differences from the flowchart illustrated in FIG. 13 will be described.

After the processing of the step SC14 is ended, in the step SC16A, the determination section 303 determines whether or not the following expression (1A) is established by using the selected individual residual vibration information NEI.

$$amplitude reference value AS - amplitude AM > threshold value λ {A}^{′} \qquad ( 1 A )$$

The threshold value λA′ is a threshold value of amplitude for determining whether or not the pre-existing head abnormality is present in the second embodiment. The threshold value λA′ is set in advance by an experiment or experience of the head manufacturer. The head manufacturer stores the threshold value λA′ in the storage circuit 320.

When the determination result in the step SC16A is negative, the determination section 303 determines whether or not the following expression (2A) is established by using the selected individual residual vibration information NEI in the step SC18A.

$$period TM - period reference value TS > threshold value {TA}^{′} \qquad ( 2 A )$$

The threshold value TA′ is a threshold value for the period for determining whether or not the pre-existing head abnormality is present. The threshold value TA′ is set in advance by the experiment or experience of the head manufacturer. The head manufacturer stores the threshold value TA′ in the storage circuit 320.

When the determination result in the step SC18A is negative, the determination section 303 determines whether or not the following expression (3A) is established by using the selected individual residual vibration information NEI in the step SC20A.

$$amplitude reference value AS - amplitude AM > threshold value λ {B}^{′} \qquad ( 3 A )$$

The threshold value λB′ is a threshold value of amplitude for determining whether or not the ejection characteristic may be lowered by the liquid pool in the second embodiment. The threshold value λB′ is set in advance by the experiment or experience of the head manufacturer. The head manufacturer stores the threshold value λB′ in the storage circuit 320. The threshold value λB′ is smaller than the threshold value λA′. For example, the threshold value λB′ may be equal to or less than 1/10 of the threshold value λA′, or may be equal to or less than 1/100 of the threshold value λA′.

When the determination result in step SC20A is negative, the determination section 303 determines whether or not the following expression (4A) is established by using the selected individual residual vibration information NEI in the step SC22A.

$$period TM - period reference value TS > threshold value {TB}^{′} \qquad ( 4 A )$$

The threshold value TB′ is a threshold value for a period for determining whether or not the ejection characteristic may be lowered by the liquid pool in the second embodiment. The threshold value TB′ is set in advance by the experiment or experience of the head manufacturer. The head manufacturer stores the threshold value TB′ in the storage circuit 320. For example, the threshold value TB′ may be equal to or less than 1/10 of the threshold value TA′, or may be equal to or less than 1/100 of the threshold value TA′.

The expression (1A) can be modified to the following expression (1A-a), and the expression (3A) can be modified to the following expression (3A-a).

$$( 1 A - a )$$

$$amplitude AM < amplitude reference value AS - threshold value λ {A}^{′}$$

$$( 3 A - a )$$

$$amplitude AM < amplitude reference value AS - threshold value λ {B}^{′}$$

Since the threshold value λB′ is smaller than the threshold value λA′, the amplitude reference value AS−the threshold value λA′ is smaller than the amplitude reference value AS−the threshold value λB′. In the second embodiment, the amplitude reference value AS−the threshold value λA′ is an example of the “second threshold value”, and the amplitude reference value AS−the threshold value λB′ is an example of the “first threshold value”.

In addition, the expression (2A) can be modified to the following expression (2A-a), and the expression (4A) can be modified to the following expression (4A-a).

$$period TM > period reference value TS + threshold value {TA}^{′} \qquad ( 2 A - a )$$

$$period TM > period reference value TS + threshold value {TB}^{′} \qquad ( 4 A - a )$$

In the second embodiment, the period reference value TS+the threshold value TA′ is an example of the “fourth threshold value”, and the period reference value TS+the threshold value TB′ is an example of the “third threshold value”.

### 3. Modification Example

Each of the above-described aspects can be variously modified. Specific aspects of modification that can be applied to each of the above-described aspects will be described below. Two or more aspects optionally selected from the following examples can be appropriately merged to the extent that they do not contradict each other.

### 3-1. First Modification Example

In the liquid pool flag setting processing of the first embodiment described above, the amplitude of the residual vibration and the period of the residual vibration are used, but the phase of the residual vibration may be used.

### 3-1-1. Operation of First Modification Example

FIG. 17 is a flowchart illustrating liquid pool flag setting processing in the first modification example. The flowchart illustrated in FIG. 17 is different from the flowchart illustrated in FIG. 13 in that a step SC18B is performed instead of the step SC18 and a step SC22B is performed instead of the step SC22, and is the same as the flowchart illustrated in FIG. 13 in other respects. Hereinafter, only differences from the flowchart illustrated in FIG. 13 will be described.

When the determination result in the step SC16 is negative, the determination section 303 determines whether or not the following expression (5) is established by using the selected individual residual vibration information NEI in the step SC18B.

$$\vert phase time HM - phase reference value HS \vert > threshold value HA \qquad ( 5 )$$

The phase time HM is a value indicating the first time at which the residual vibration of the selected individual residual vibration information NEI is at the center of the amplitude. The phase reference value HS is a value indicating the first time at which the residual vibration with respect to the normal ejection nozzle Nz-S is at the center of the amplitude. The threshold value HA is a threshold value used to determine whether or not the pre-existing head abnormality is present, and is a threshold value of the time at which the phase is 180 degrees, in other words, a threshold value of the first time at which the residual vibration is at the center of the amplitude. The 180 degrees is an example of a “specific phase”. The phase reference value HS and the threshold value HA are set in advance by an experiment or experience of the head manufacturer. The head manufacturer stores the phase reference value HS and the threshold value HA in the storage circuit 320.

When the determination result in the step SC20 is negative, the determination section 303 determines whether or not the following expression (6) is established by using the selected individual residual vibration information NEI in the step SC22B.

$$\vert phase time HM - phase reference value HS \vert > threshold value HB \qquad ( 6 )$$

The threshold value HB is a threshold value for determining whether or not the ejection characteristic may be lowered by the liquid pool, and is a threshold value of the first time at which the residual vibration is at the center of the amplitude. The threshold value HB is set in advance by an experiment or experience of the head manufacturer. The head manufacturer stores the threshold value HB in the storage circuit 320. The threshold value HB is smaller than the threshold value HA. For example, the threshold value HB may be equal to or less than 1/10 of the threshold value HA, or may be equal to or less than 1/100 of the threshold value HA.

With respect to the phase of the residual vibration, a case where the selected nozzle Nz is determined to have the pre-existing head abnormality is a case where the expression (5) is established. A case where the expression (5) is established is a case where either one of the following expression (5-a) or expression (5-b) is established.

$$phase time HM > phase reference value HS + threshold value HA \qquad ( 5 - a )$$

$$phase time HM < phase reference value HS - threshold value HA \qquad ( 5 - b )$$

In addition, a case where the liquid pool flag is set in the selected nozzle Nz is a case where the expression (5) is not established and the expression (6) is established. A case where the expression (5) is not established and the expression (6) is established is a case where either one of the following expression (6-a) or expression (6-b) is established.

$$phase reference value HS + threshold value HB < phase time HM \leq phase reference value HS + threshold value HA \qquad ( 6 - a )$$

$$phase reference value HS - threshold value HA \leq phase time HM < phase reference value HS - threshold value HB \qquad ( 6 - b )$$

A case where the selected nozzle Nz has normal ejection is a case where the expression (6) is not established. A case where the expression (6) is not established is a case where the following expression (6-c) is established.

$$period reference value HS - threshold value HB \leq phase time HM \leq period reference value HS + threshold value HB \qquad ( 6 - c )$$

Since the threshold value HB is smaller than the threshold value HA, the phase reference value HS+the threshold value HA is longer than the phase reference value HS+the threshold value HB. The phase reference value HS+the threshold value HA is an example of a “sixth threshold value”, and the phase reference value HS+the threshold value HB is an example of a “fifth threshold value”.

In the flowchart illustrated in FIG. 17, the value indicating the first time at which the residual vibration is at the center of the amplitude is used as the time at which the potential of the residual vibration is at 180 degrees, but the present disclosure is not limited thereto. For example, the phase of the residual vibration may be a value indicating the second or subsequent time at which the residual vibration is at the center of the amplitude. Further, the phase of the residual vibration may not be the time at which the residual vibration is at the center of the amplitude, and may be, for example, the time at which the phase is at 90 degrees or 270 degrees, specifically, the time at which the residual vibration has an extreme value. However, due to the fact that the amplitude of the residual vibration uses the first or subsequent extreme value of the residual vibration, it is preferable not to use the extreme value of the residual vibration as the phase of the residual vibration. When noise affects the extreme value of the residual vibration, this is because the noise affects not only the amplitude of the residual vibration, but also the phase of the residual vibration.

In addition, in the flowchart illustrated in FIG. 17, the determination section 303 determines the nozzle Nz in which the ejection characteristic may be lowered by the liquid pool by using the amplitude of the residual vibration and the phase of the residual vibration, but the present disclosure is not limited thereto. For example, the determination section 303 may determine the nozzle Nz in which the ejection characteristic may be lowered by the liquid pool by using the period of the residual vibration and the phase of the residual vibration. Alternatively, the determination section 303 may determine the nozzle Nz in which the ejection characteristic may be lowered by the liquid pool by using the amplitude of the residual vibration, the period of the residual vibration, and the phase of the residual vibration. Alternatively, the determination section 303 may determine the nozzle Nz in which the ejection characteristic may be lowered by the liquid pool by using one element of the amplitude of the residual vibration, the period of the residual vibration, and the phase of the residual vibration.

The first modification example is a modified aspect in which the phase of the residual vibration is used instead of the period of the residual vibration in the first embodiment, but a modified aspect in which the phase of the residual vibration is used instead of the period of the residual vibration in the second embodiment can also be adopted. For example, in the step SC18A, the determination section 303 determines whether or not the following expression (2B) is established by using the selected individual residual vibration information NEI.

$$period time HM - period reference value HS > threshold value {HA}^{′} \qquad ( 2 B )$$

The threshold value HA′ is a threshold value used to determine whether or not the pre-existing head abnormality is present, and is a threshold value of the time at which the phase is 180 degrees, in other words, a threshold value of the first time at which the residual vibration is at the center of the amplitude. The threshold value HA′ is set in advance by the experiment or experience of the head manufacturer. The head manufacturer stores the threshold value HA′ in the storage circuit 320.

In addition, in the step SC22A, the determination section 303 determines whether or not the following expression (4B) is established by using the selected individual residual vibration information NEI.

$$period TM - period reference value TS > threshold value {TB}^{′} \qquad ( 4 B )$$

The threshold value HB′ is a threshold value for determining whether or not the ejection characteristic may be lowered by the liquid pool, and is a threshold value of the first time at which the residual vibration is at the center of the amplitude. The threshold value HB′ is set in advance by the experiment or experience of the head manufacturer. The head manufacturer stores the threshold value HB′ in the storage circuit 320. The threshold value HB′ is smaller than the threshold value HA′. For example, the threshold value HB′ may be equal to or less than 1/10 of the threshold value HA′, or may be equal to or less than 1/100 of the threshold value HA′.

### 3-1-2. Summary of First Modification Example

Hereinafter, in order to facilitate understanding, an example of the “specific phase” is referred to as “180 degrees”, the individual residual vibration information NEI related to the residual vibration in the pressure chamber CV communicating with the target nozzle Nz is referred to as the “first individual information”, and the individual residual vibration information NEI related to the residual vibration in the pressure chamber CV communicating with at least one peripheral nozzle Nz positioned around the target nozzle Nz is referred to as the “second individual information”. Further, the phase reference value HS+the threshold value HB, which is an example of the “fifth threshold value” used for determining the liquid pool formation abnormality, is referred to as a “first upper limit phase threshold value”, and the phase reference value HS+the threshold value HA, which is an example of the “sixth threshold value” used for determining the pre-existing head abnormality, is referred to as a “second upper limit phase threshold value”, to describe the summary of the first modification example.

In the step SC4, when the time at which the residual vibration related to the first individual information is at the specific phase is later than the first upper limit phase threshold value and the time at which the residual vibration related to the second individual information is at 180 degrees is later than the first upper limit phase threshold value, the determination section 303 determines that the liquid pool formation abnormality is generated.

According to the first modification example, whether or not the liquid pool formation abnormality is generated can be accurately determined by using the phase of the residual vibration and the first upper limit phase threshold value.

In addition, in the step SC4, when the time at which the residual vibration related to the first individual information or the second individual information is at 180 degrees is earlier than the first upper limit phase threshold value, the determination section 303 determines that the liquid pool formation abnormality and the pre-existing head abnormality are not generated.

According to the first modification example, although the period of the residual vibration of one of the first individual information and the second individual information is affected by noise, it can be accurately determined that the liquid pool formation abnormality and the pre-existing head abnormality are not generated.

In addition, in the step SC4, when the time at which the residual vibration related to the first individual information is at 180 degrees is later than the second upper limit phase threshold value, the determination section 303 determines that the pre-existing head abnormality is generated, and the second upper limit phase threshold value is later than the first upper limit phase threshold value.

According to the first modification example, when the period of the residual vibration related to the first individual information is lengthened and is longer than the second upper limit period threshold value, it can be determined that the pre-existing head abnormality is generated.

### 3-2. Second Modification Example

When the ink jet printer 100 cannot be temporarily connected to the cloud server CS, the ink jet printer 100 stores the residual vibration information NI in the storage circuit 160 of the ink jet printer 100. Hereinafter, the second modification example will be described.

### 3-2-1. Operation of Second Modification Example

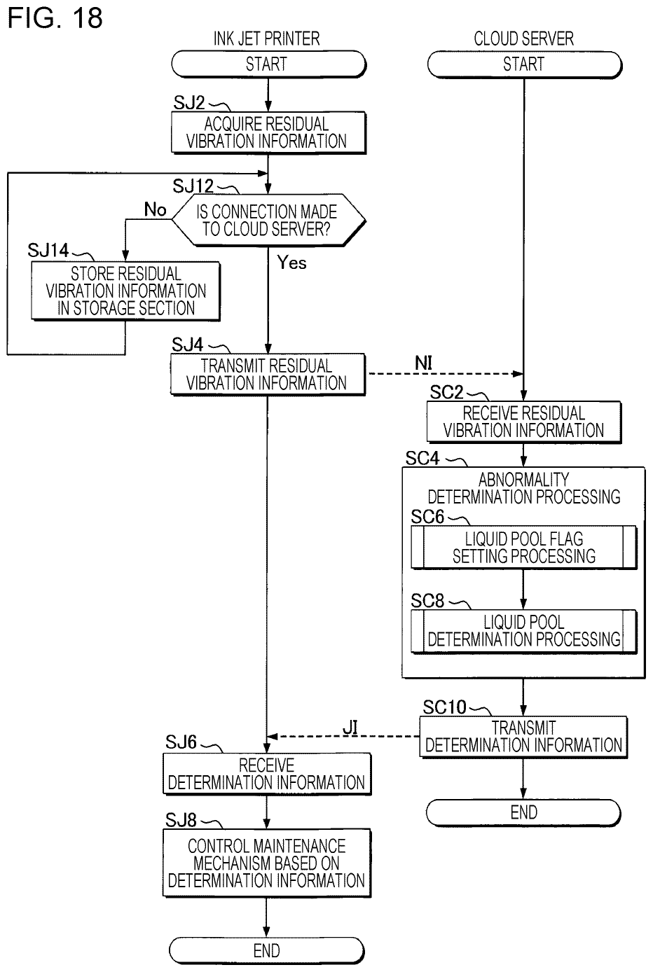

FIG. 18 is a flowchart illustrating operations of the ink jet system 10 according to the second modification example. The flowchart illustrated in FIG. 18 is different from the flowchart illustrated in FIG. 12 in that the processing of a step SJ12 and the processing of a step SJ14 are executed between the processing of the step SJ2 and the processing of the step SJ4, and is the same as the flowchart illustrated in FIG. 12 in other respects. Hereinafter, only differences from the flowchart illustrated in FIG. 12 will be described.

After the processing of step SJ2 is ended, in step SJ12, the control circuit 170 functions as the first transmission section 173 and determines whether or not connection is made to the cloud server CS. When the determination result in the step SJ12 is negative, in the step SJ14, the control circuit 170 causes the storage circuit 160 to store the residual vibration information NI acquired in the step SJ2. The storage circuit 160 is an example of a “storage section”. After the processing of the step SJ14 is ended, the control circuit 170 executes the processing of the step SJ12 again. When the determination result in the step SJ12 is positive, the control circuit 170 executes the processing in the step SJ4. In the processing of the step SJ4, when the processing of the step SJ14 is executed, the control circuit 170 transmits the residual vibration information NI stored in the storage circuit 160 to the cloud server CS.

Although not illustrated in FIG. 18, the processing of the step SJ14 may be executed only once at the beginning. In addition, when a case where the determination result of the step SJ12 is negative is performed a plurality of times, the control circuit 170 may end the series of processing illustrated in FIG. 18. Then, the control circuit 170 transmits information indicating that the residual vibration information NI cannot be transmitted to the cloud server CS to the processing apparatus 200. The processing apparatus 200 displays, on the display device 270, a dialog indicating that the residual vibration information NI cannot be transmitted to the cloud server CS and prompting the user U to select whether or not to execute the recording processing of the image data Img in the ink jet printer 100. When the user U selects the recording processing to be executed by the ink jet printer 100, the ink jet printer 100 executes the recording processing.

In addition, as illustrated in FIG. 5, the ink jet printer 100 includes the storage circuit 160 in the printer main body, but the liquid ejecting head HU may include the storage circuit. In the step SJ14, the residual vibration information NI may be stored in the storage circuit of the liquid ejecting head HU.

### 3-2-2. Summary of Second Modification Example

In the above description, in the second modification example, the ink jet printer 100 is provided with the storage circuit 160, and the first transmission section 173 stores the residual vibration information NI acquired by the processing of the step SJ4 in the storage circuit 160 when the ink jet printer 100 and the cloud server CS are unable to be connected to each other in the step SJ14.

The ink jet printer 100 and the cloud server CS may be temporarily unable to be connected to each other due to reasons such as temporary interruption of the service of the cloud server CS or communication congestion between the ink jet printer 100 and the cloud server CS. According to the second modification example, although the ink jet printer 100 and the cloud server CS are unable to be connected to each other, when the residual vibration information NI is stored in the storage circuit 160, the residual vibration information NI can be transmitted to the cloud server CS when the ink jet printer 100 and the cloud server CS are connected.

### 3-3. Third Modification Example

In each of the above-described aspects, the cloud server CS functions as the determination section 303, but the control circuit 170 may function as the determination section 303.

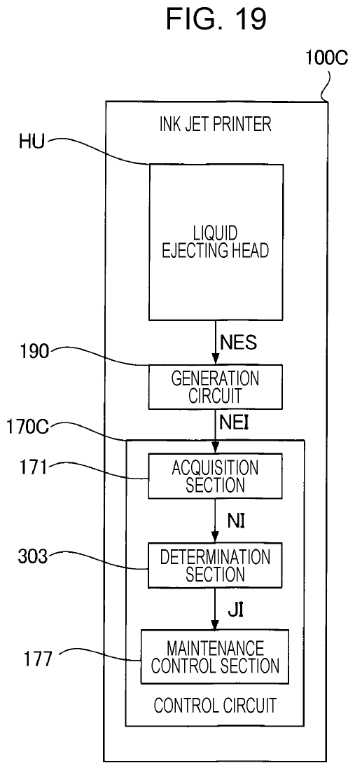

FIG. 19 is a diagram illustrating functions of an ink jet printer 100C according to the third modification example. The ink jet printer 100C is different from the ink jet printer 100 in that a control circuit 170C is provided instead of the control circuit 170. The control circuit 170C is different from the control circuit 170 in that the control circuit 170C functions as the acquisition section 171, the determination section 303, and the maintenance control section 177. That is, the control circuit 170C functions as the determination section 303 and performs the processing of the step SC4.

According to the third modification example, the control circuit 170C performs the processing of the step SC4, so that the speed of obtaining the determination information JI can be improved by not having to execute the transmission of the residual vibration information NI and the reception of the determination information JI as compared with the ink jet system 10 in the first embodiment. For example, when the head manufacturer manufactures the printer main body in addition to the liquid ejecting head HU, the third modification example may be applied.

In the third modification example, the control circuit 170C performs the processing of the step SC4, but the control circuit 170C may transmit the residual vibration information NI to the processing apparatus 200, and the control circuit 210 of the processing apparatus 200 may perform the processing of the step SC4.

In the third modification example, after the control circuit 170C performs the processing of the step SC4, the control circuit 170C may transmit the determination information JI to the cloud server CS. When the determination information JI is received, the cloud server CS stores the determination information JI in the storage circuit 320. In addition, the control circuit 170C may transmit the residual vibration information NI and the determination information JI to the cloud server CS. When the cloud server CS receives the residual vibration information NI and the determination information JI, the cloud server CS associates the residual vibration information NI with the determination information JI and stores the residual vibration information NI and the determination information JI in the storage circuit 320. In addition, the control circuit 170C may transmit the residual vibration information NI and the determination information JI to the cloud server CS only when the determination information JI includes one or more identifiers among the second identifier and the third identifier.

In addition, the ink jet printer 100C according to the third modification example may not be connected to the cloud server CS. When a service support person of the head manufacturer visits the printer manufacturer or the user U, the ink jet printer 100C or the processing apparatus 200 copies the determination information JI or the like to the portable storage device brought by the service support person. The portable storage device is, for example, an SSD. SSD is an abbreviation for Solid State Drive. Then, when the service support person returns to the business office of the head manufacturer, the PC that is connectable to the cloud server CS transmits the determination information JI or the like stored in the portable storage device to the cloud server CS.

### 3-4. Fourth Modification Example

In each of the above-described aspects, the cloud server CS determines whether or not the pre-existing head abnormality is generated based on the residual vibration information NI, in addition to whether or not the liquid pool formation abnormality is generated, but the present disclosure is not limited thereto. For example, the cloud server CS may determine only whether or not the liquid pool formation abnormality is generated based on the residual vibration information NI, and may not determine whether or not the pre-existing head abnormality is generated.

### 3-5. Fifth Modification Example

In each of the above-described aspects, the cloud server CS acquires the residual vibration information NI having the 2M pieces of the individual residual vibration information NEI, but the present disclosure is not limited thereto. The cloud server CS may acquire the residual vibration information NI having two or more pieces of the individual residual vibration information NEI, and may determine whether or not the liquid pool formation abnormality is generated based on the residual vibration information NI.

### 3-6. Sixth Modification Example

In each of the above-described aspects, when the ink jet printer 100 is connectable to the network NW, the communication device 150 is connected to the network NW, but the present disclosure is not limited thereto. For example, when the liquid ejecting head HU includes a communication device, the communication device may communicate with the network NW.

### 3-7. Seventh Modification Example

In each of the above aspects, the individual residual vibration information NEI is information in which the time information and the potential value are associated with each other, but the individual residual vibration information NEI is not limited to information in which the time information and the potential value are associated with each other. For example, the individual residual vibration information NEI may be one value or a plurality of values among a value indicating the amplitude of the residual vibration, a value indicating the period of the residual vibration, or a value indicating the time at which the residual vibration is at a specific phase. For example, the generation circuit 190 specifies the amplitude of the residual vibration from the residual vibration signal NES, and outputs a value indicating the specified amplitude as the individual residual vibration information NEI to the control circuit 170.

### 3-8. Eighth Modification Example

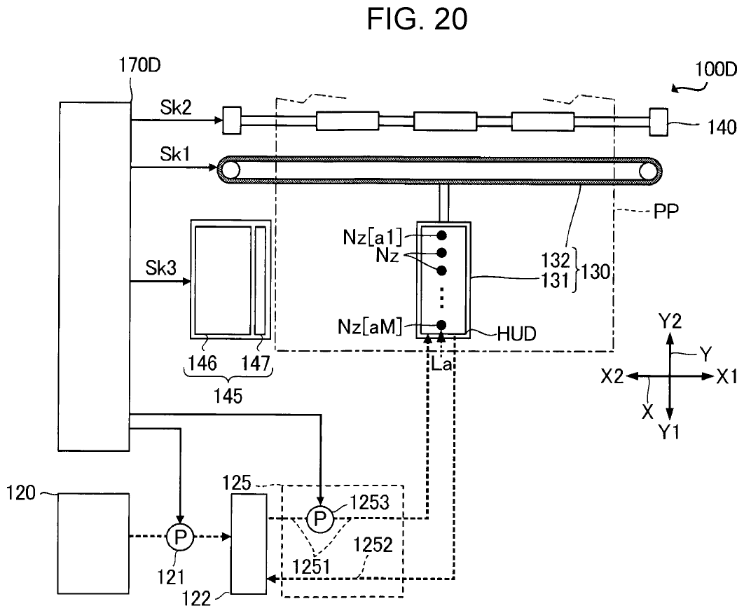

The liquid ejecting head HU may be a circulation type head having a so-called circulation flow path. Hereinafter, the eighth modification example will be described with reference to FIG. 20.

FIG. 20 is a schematic diagram illustrating an example of a configuration of an ink jet printer 100D according to the eighth modification example. The ink jet printer 100D is different from the ink jet printer 100 in that the ink jet printer 100D includes the liquid ejecting head HUD instead of the liquid ejecting head HU, includes a control circuit 170D instead of the control circuit 170, and further includes a pump 121, a liquid storage section 122, and a circulation mechanism 125. The liquid ejecting head HUD includes an internal circulation flow path (not illustrated). In addition, as illustrated in FIG. 20, the liquid ejecting head HUD includes the one nozzle row La. As described above, the present disclosure can also be applied to the ink jet printer 100 having one nozzle row.

The pump 121 is provided between the liquid container 120 and the liquid storage section 122. The liquid storage section 122 stores the ink to be supplied to the liquid ejecting head HUD. The circulation mechanism 125 is a mechanism that supplies the ink to the liquid ejecting head HUD and collects the ink discharged from the liquid ejecting head HUD for resupply to the liquid ejecting head HUD. The circulation mechanism 125 includes a supply path 1251 for supplying the ink from the liquid storage section 122 to the liquid ejecting head HU, a collection path 1252 for collecting the ink from the liquid ejecting head HU to the liquid storage section 122, and a flow mechanism 1253 for appropriately flowing the ink. The flow mechanism 1253 is provided between the supply paths 1251. The flow mechanism 1253 flows the ink in the supply path 1251 under the control of the control circuit 170D. The flow mechanism 1253 is, for example, a pump, a compressor, or the like.

When the determination information JI is received from the cloud server CS, the control circuit 170D functions as the maintenance control section 177 in the eighth modification example. When the determination information JI includes the third identifier indicating that the liquid pool formation abnormality is generated, the maintenance control section 177 in the eighth modification example controls the flow mechanism 1253 to increase the pressure of the ink in the circulation flow path in the liquid ejecting head HUD or to lower the pressure of the ink, instead of the wiping processing or in addition to the wiping processing.

### 3-9. Ninth Modification Example

In each of the above-described aspects, the serial type ink jet printer 100 in which the liquid ejecting head HU is reciprocated in the direction along the X-axis is exemplified, but the present disclosure is not limited to such an aspect. The ink jet printer 100 may be a line type liquid ejecting apparatus in which the plurality of nozzles Nz are distributed over the entire width of the medium PP.

### 3-10. Other Modification Examples

The above-described ink jet printer 100 can be employed in various devices such as a facsimile machine and a copier, in addition to a device dedicated to printing. However, the application of use of the recording apparatus of the present disclosure is not limited to printing. For example, a recording apparatus that ejects a solution of a coloring material is used as a manufacturing device forming a color filter of a liquid crystal display device. In addition, a recording apparatus that ejects a solution of a conductive material is used as a manufacturing device for forming wiring and electrodes of a wiring substrate.

What is claimed is:

1. A control method of a liquid ejecting apparatus that includes a liquid ejecting head having a plurality of piezoelectric elements, a plurality of pressure chambers which apply pressure to an internal liquid by respectively driving the plurality of piezoelectric elements, and a plurality of nozzles which respectively communicate with the plurality of pressure chambers and from which the liquid is ejected, and that is configured to eject the liquid onto a medium, the control method comprising:
an acquisition step of acquiring residual vibration information on residual vibration in the pressure chambers after applying a voltage to one or more of the plurality of piezoelectric elements; and
a determination step of determining whether or not a first abnormality, which is an abnormality in which liquid pool is formed on a nozzle surface on which the plurality of nozzles are provided, is generated based on the residual vibration information.

2. The control method according to claim 1, wherein
the residual vibration information includes first individual information on the residual vibration in the pressure chamber communicating with a target nozzle among the plurality of nozzles and second individual information on the residual vibration in the pressure chamber communicating with at least one peripheral nozzle positioned around the target nozzle, and
the determination step determines whether or not the first abnormality is generated based on the first individual information and the second individual information.

3. The control method according to claim 2, wherein the peripheral nozzle includes an adjacent nozzle adjacent to the target nozzle.

4. The control method according to claim 2, wherein
the determination step further determines whether or not a second abnormality, which is an abnormality different from the first abnormality and is an abnormality of the liquid ejecting head caused by the liquid ejecting head, is generated based on the first individual information.

5. The control method according to claim 4, wherein
the determination step determines that the first abnormality is generated when an amplitude of the residual vibration related to the first individual information is smaller than a first threshold value and an amplitude of the residual vibration related to the second individual information is smaller than the first threshold value.

6. The control method according to claim 5, wherein
the determination step determines that the first abnormality and the second abnormality are not generated when the amplitude of the residual vibration related to the first individual information or second individual information is greater than the first threshold value.

7. The control method according to claim 6, wherein
the determination step determines that the second abnormality is generated when the amplitude of the residual vibration related to the first individual information is smaller than a second threshold value, and
the second threshold value is smaller than the first threshold value.

8. The control method according to claim 4, wherein
the determination step determines that the first abnormality is generated when a period of the residual vibration related to the first individual information is longer than a third threshold value and an amplitude of the residual vibration related to the second individual information is longer than the third threshold value.

9. The control method according to claim 8, wherein
the determination step determines that the first abnormality and the second abnormality are not generated when the period of the residual vibration related to the first individual information or second individual information is shorter than the third threshold value.

10. The control method according to claim 9, wherein
the determination step determines that the second abnormality is generated when the period of the residual vibration related to the first individual information is longer than a fourth threshold value, and
the fourth threshold value is longer than the third threshold value.

11. The control method according to claim 4, wherein
the determination step determines that the first abnormality is generated when a time at which the residual vibration related to the first individual information is at a specific phase is later than a fifth threshold value, and a time at which the residual vibration related to the second individual information is at the specific phase is later than the fifth threshold value.

12. The control method according to claim 11, wherein
the determination step determines that the first abnormality and the second abnormality are not generated when the time at which the residual vibration related to the first individual information or second individual information is at the specific phase is earlier than the fifth threshold value.

13. The control method according to claim 12, wherein
the determination step determines that the second abnormality is generated when the time at which the residual vibration related to the first individual information is at the specific phase is later than a sixth threshold value, and
the sixth threshold value is later than the fifth threshold value.

14. The control method according to claim 1, further comprising:
by using a server provided outside the liquid ejecting apparatus,
a transmission step of transmitting the residual vibration information acquired in the acquisition step from the liquid ejecting apparatus to the server; and
a reception step of receiving determination information indicating a determination result by the determination step from the server, wherein
the server performs the determination step.

15. The control method according to claim 14, wherein
the liquid ejecting apparatus is provided with a storage section, and
in the transmission step, when the liquid ejecting apparatus and the server are not connectable, the residual vibration information acquired in the acquisition step is stored in the storage section.

16. The control method according to claim 1, wherein
the liquid ejecting apparatus performs the determination step.

17. A liquid ejecting apparatus that includes a liquid ejecting head having a plurality of piezoelectric elements, a plurality of pressure chambers which apply pressure to an internal liquid by respectively driving the plurality of piezoelectric elements, and a plurality of nozzles which respectively communicate with the plurality of pressure chambers and from which the liquid is ejected, and that is configured to eject the liquid onto a medium, the liquid ejecting apparatus comprising:
an acquisition section configured to acquire residual vibration information on residual vibration in the pressure chambers after applying a voltage to one or more of the plurality of piezoelectric elements; and
a determination section configured to determine whether or not a first abnormality, which is an abnormality in which liquid pool is formed on a nozzle surface on which the plurality of nozzles are provided, is generated based on the residual vibration information.

18. An ink jet system comprising:
a liquid ejecting apparatus that includes a liquid ejecting head having a plurality of piezoelectric elements, a plurality of pressure chambers which apply pressure to an internal liquid by respectively driving the plurality of piezoelectric elements, and a plurality of nozzles which respectively communicate with the plurality of pressure chambers and from which the liquid is ejected, and that is configured to eject the liquid onto a medium; and a server provided outside the liquid ejecting apparatus, wherein
the liquid ejecting apparatus
acquires residual vibration information on residual vibration in the pressure chambers after applying a voltage to one or more of the plurality of piezoelectric elements, and
transmits the residual vibration information from the liquid ejecting apparatus to the server, and
the server
determines whether or not a first abnormality, which is an abnormality in which liquid pool is formed on a nozzle surface on which the plurality of nozzles are provided, is generated based on the residual vibration information, and
transmits determination information indicating a determination result indicating whether or not the first abnormality is generated to the liquid ejecting apparatus.
